(19) United States
(12) Patent Application Publication
(10) Pub. No.: US 2002/0120538 A1
(43) Pub. Date: Aug. 29, 2002

(54) Multi-channel grants management system

(75) Inventors: Chris Royal Corrie, Fairfax, VA (US); David Lawrence Colangelo, Bristow, VA (US); Christopher D. Martin, Glen Allen, VA (US)

Correspondence Address: STAAS & HALSEY LLP, 700 11TH STREET, NW, SUITE 500, WASHINGTON, DC, 20001, US

(73) Assignee: American Management Systems, Fairfax, VA

(21) Appl. No.: 09/928,364

(22) Filed: Aug. 14, 2001

Related U.S. Application Data
(60) Provisional application No. 60/267,142, filed on Feb. 8, 2001.

(51) Int. Cl. G06F 17/60

(52) U.S. Cl. 705/35

(57) ABSTRACT

A multi-channel management system and method includes a financial management system and a web-based portal. A grants management system receives a grant initiative from a granting agency and receives a grant initiative application from an applicant via one of a web-portal, fax, in-person, and telephone. The grants management system and the financial management system are integrally connected facilitating transmission and messaging between the grants management system and the financial management system, and allowing the grants management system to dynamically manage grant initiative transactions and financial transactions associated with a life-cycle of a grant initiative from the granting agency by automatically triggering events.

### DESCRIPTION OF THE RELATED ART

Currently, the federal government disburses over $300 billion annually in the form of grants and financial assistance. The process of publicizing grant availability, soliciting grant applications, reviewing the grant applications, making a grant award, and administering that award is currently a manual, labor intensive process for most government agencies. There is no common clearing-house for posting government grant availability. Applying for a grant is often entirely paper-based. Further, the review process is extremely labor intensive, with reviewers often being flown to a central location to evaluate grant proposals.

Throughout the application and review process, applicants often must deal with different representatives of the granting agency, as well as contractors outside of the granting agency who help execute the grant application and award process. These interactions may occur over many communication channels, including telephone, e-mail, in person, and over a web site. Without the ability to capture the applicant information in a single system and without the ability to provide consistent access to the grant application across the communications channels, the applicant often receives conflicting information when inquiring about the status of a grant application, or the qualifications necessary to apply for a particular grant. Some of this information is only available in person, or through a telephone call. All of these inefficiencies result in an increased cost in grants administration, a diminished quality of the applications, frustration among applicants, and potentially, awarding the grant to a less-than-ideal candidate.

Federal grants management is an area that is ripe for automation and the application of electronic commerce solutions. Recognizing this, the federal government has begun a number of initiatives to investigate and apply grants management best practices across grant providing agencies. The more prominent organizations and efforts include: the Inter-Agency Electronic Grants Committee (“IAEGC”) whose mission is to coordinate, promote and facilitate the effective use of electronic commerce (“EC”) throughout the federal grants community, under sponsorship of the Federal Electronic Commerce Program Office. The US Electronic Grants Project, which is a workgroup under the IAEGC, is building software that permits grant customers to exchange data and files with federal agency databases through data screens running in a web browser. The Federal Commons, which is coordinated through the IAEGC, is a web site that attempts to provide a common face of the government to grant recipient organizations for the purpose of grants administration. The Chief Financial Officer's Council (CFOC) issued a directive to stop civilian agencies from developing new grant draw-down systems and to instead migrate to the Treasury's Automated Standard Application for Payments (“ASAP”) or the Health and Human Services' Payment Management System (“PMS”).

Despite the worthwhile effort of these groups, they have had difficulty in reaching consensus on standard grants management practices and systems. One of the primary reasons for their difficulties lies in the varied nature of the grants themselves. Different agencies have vastly diverse procedures and requirements related to grants management.

Nonetheless, there are many similarities in the grant award, distribution, and monitoring process across agencies. It is obvious that the use of electronic business technologies to improve these processes will continue to increase in response to increasing the efficiency of service demanded by government partners and grant recipients and decreasing grant administration overhead and expanding the amount of time that is spent on major grant initiatives. Further, Congress and the public at large will increase expectations for reporting quality and program accountability.

The partnership between government agencies and grant recipient organizations will continue to evolve in more synergistic ways, with the services provided by government agencies adding value to the funds that the grant recipient organizations receive.

A CRM (“Customer Relationship Management”) solution set, such as SIEBEL SYSTEMS, Inc., or CLARIFY (acquired by NORTEL), or VANTIVE (acquired by PEOPLESOFT) is provided rather than a single specific software application. Accordingly, the Siebel-based grants solution is highly customizable and configurable and can be quickly tailored for an individual agency or grant program. However, the standard configurations of the Siebel application does not provide functionalities, such as the ability to track, update, and commit financial transactions, concerning grant funding, award distribution, and closeout.

A system is needed that would provide for a customized environment for the factors considered by a granting agency or grantor when awarding a grant. The factors considered for awarding a grant are specific to each particular granting agency or grantor. Thus, prior grants systems are not flexible and dynamic enough to provide an environment where different types of grants requiring different factors to consider for allowing such grants. Typically, the grant information is hard coded for each grant. The Multi-Channel Grants Management System is a system that provides a customizable set of criteria necessary for the grantors to consider for awarding a grant.

A person applying for a grant competes with other applicants. The granting agency or grantor has a fixed amount of money to award as a grant, which makes it imperative that the grant funds be distributed or given out to the best-qualified applicants. Thus, the granting agency needs a system that will provide a flexible environment that allows the granting agency to enter those factors that need to be considered for awarding the grant. Also, the granting agency needs a system that would allow access to or review of all the applications submitted for a particular grant from all applicants and determine therefrom the best-qualified applicant. The system would permit the granting agency to compare the relative merits of each applicant.

### SUMMARY OF THE INVENTION

A multi-channel grants management system is provided as a single, integrated system that supports grants management from cradle to grave. A grants management system and a financial management system are integrally connected in the multi-channel grants management system facilitating transmission and messaging between the grants management system and the financial management system, and dynamically managing grant initiative transactions and financial transactions associated with a life-cycle of the grant initiative by automatically triggering events.

It is an aspect of the present invention to provide for a system and method where a grants management system is operatively connected to a granting agency and a financial management system; and an integration unit providing real-time integration between the grants management system and the financial management system allowing the grants management system to dynamically manage grant initiative transactions and financial transactions associated with a life-cycle of a grant initiative from the granting agency by automatically triggering events.

It is an aspect of the present invention to provide for a multi-channel management system including a financial management system; and a grants management system receiving a grant initiative from a granting agency, receiving a grant initiative application from an applicant via one of a web-portal, fax, in-person, and telephone, integrally connected to the financial management system to facilitate transmission and messaging between the grants management system and the financial management system, and dynamically managing grant initiative transactions and financial transactions associated with a life-cycle of the grant initiative by automatically triggering events.

It is another aspect of the present invention to provide for a method and a computer readable storage medium including receiving a grant initiative from a granting agency via a web-based portal; automatically retrieving and notifying a potential and/or past applicant of availability of the grant initiative; receiving a grant initiative application from an applicant via the web-based portal; dynamically evaluating the grant initiative application using customizable decision rule data structures and generating a score; and interfacing with a financial management system to dynamically manage grant initiative transactions and financial transactions associated with a life-cycle of the grant initiative by automatically triggering events.

It is another aspect of the present invention to provide for a method and a computer readable storage medium including applying for a grant initiative over a web-based portal; dynamically notifying an applicant of problems while applying for the grant initiative; receiving a grant initiative application; dynamically selecting a reviewer that is best qualified to review the grant initiative application according to the grant initiative; notifying the reviewer of the grant initiative assigned for review; evaluating the grant initiative application using customizable decision rule data structures and generating a score; and interfacing with a financial management system to dynamically manage grant initiative transactions and financial transactions associated with a life-cycle of the grant initiative by automatically triggering events.

It is further an aspect of the present invention to provide for a method and a computer readable storage medium including receiving a grant initiative from a granting agency via a web-based portal; receiving a grant initiative application from an applicant via the web-based portal; dynamically selecting a reviewer that is best qualified to review the application according to the grant initiative from the granting agency and to generate a score; dynamically evaluating the grant initiative application using customizable decision rule data structures and generating a score; combining the scores from the reviewer and the grants management system to create a composite score to determine an application to award the grant initiative; managing financial information of the grant initiative by a grants management system by automatically triggering events including a requests of grants financial activities process, an information transfer process, and a financial close out process; and interfacing with a financial management system to dynamically manage grant initiative transactions and financial transactions associated with a life-cycle of the grant initiative, with the life-cycle including pre-application, grant publication, application intake, application review or assessment, grant award, grant administration, and grant closeout.

These together with other aspects and advantages, which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The various aspects and advantages of the invention will become apparent and more readily appreciated from the following description of the preferred embodiments, taken in conjunction with the accompanying drawings of which:

FIG. 1 is a diagram of a system architecture in accordance with the present invention;

FIG. 2A is a diagram of a grantee/applicant web-access login screen, in accordance with the present invention;

FIG. 2B is a diagram of a grantee/applicant self-service main menu, in accordance with the present invention;

FIG. 2C is a diagram of list of all published grant initiatives and objectives, in accordance with the present invention;

FIG. 2D is a diagram of a search screen for grant initiatives, in accordance with the present invention;

FIG. 2E is a diagram of a grant initiative summary screen, in accordance with the present invention;

FIG. 2F is a diagram of an online application detail screen, in accordance with the present invention;

FIG. 2G is a diagram of an online application form screen, in accordance with the present invention;

FIG. 2H is a diagram of a current status application screen, in accordance with the present invention;

FIG. 2I is a diagram of a view of details of an approved grant agreement screen, in accordance with the present invention;

FIG. 2J is a diagram of a request drawdown screen, in accordance with the present invention;

FIG. 2K is a diagram of a help screen, in accordance with the present invention;

FIG. 2L is a diagram of a review status screen, in accordance with the present invention;

FIG. 3A is a diagram of an initiative entry view screen, in accordance with the present invention;

FIG. 3B is a diagram of an initiative “attachments” screen, in accordance with the present invention;

FIG. 3C is a diagram of an “applications” screen, in accordance with the present invention;

FIG. 3D is a diagram of an “all applications” grant screen, in accordance with the present invention;

FIG. 3E is a diagram of an application “activities” screen, in accordance with the present invention;

FIG. 3F is a diagram of an application assessment screen, in accordance with the present invention;

FIG. 3G is a diagram of an application notes screen, in accordance with the present invention;

FIG. 3H is a diagram of an application finance screen, in accordance with the present invention;

FIG. 3I is a diagram of an agreement payments screen, in accordance with the present invention;

FIG. 4A is a diagram of an “All Grant Organizations” screen, in accordance with the present invention;

FIG. 4B is a diagram of an “Organization Contacts” screen, in accordance with the present invention;

FIG. 5 is a diagram of an accounting history screen, in accordance with the present invention;

FIG. 6A is a diagram of an initiative setup process, in accordance with the present invention;

FIG. 6B is a diagram of a pre-application and application process, in accordance with the present invention;

FIG. 6C is a diagram of a reviewer assignment process, in accordance with the present invention;

FIG. 6D is a diagram of a review and ranking process, in accordance with the present invention;

FIG. 6E is a diagram of a grant initiative selection for award process, in accordance with the present invention;

FIG. 6F is a diagram of requests of a grants financial activities process, in accordance with the present invention;

FIG. 6G is a diagram of information transfer process, in accordance with the present invention; and

FIG. 6H is a diagram of a financial close out process, in accordance with the present invention.

### DESCRIPTION OF THE PREFERRED EMBODIMENTS

The Multi-Channel Grants Management System (“MGMS”) is built on a foundation of state-of-the-art customer relationship management software, which ensures that information in a grants management system and in a financial management system are maintained in a centralized database. The underlying architecture of the MGMS allows the information to be accessed from a variety of communication channels and ensures that it is always presented in a consistent manner. Multi-channel coordination means that the system tracks all questions and correspondence received from a grant initiative applicant as well as the results of that correspondence regardless of the communication means used to communicate between the granting agency and the grantee.

The grants management system application program of the present system is flexible and easy to configure. Because the entire look and feel of the grants management system, which includes field names, field sizes, the number of fields, screen layouts, and business logic is determined by reading a repository of metadata, MGMS can be uniquely configured to meet the specific needs of any granting agency without requiring any custom development. The MGMS is designed to support specific, well-defined grants management processes. Also, the MGMS supports granting agency specific configuration changes or updates to any field, screen, or decision rule at or after the time that the grant initiative is published.

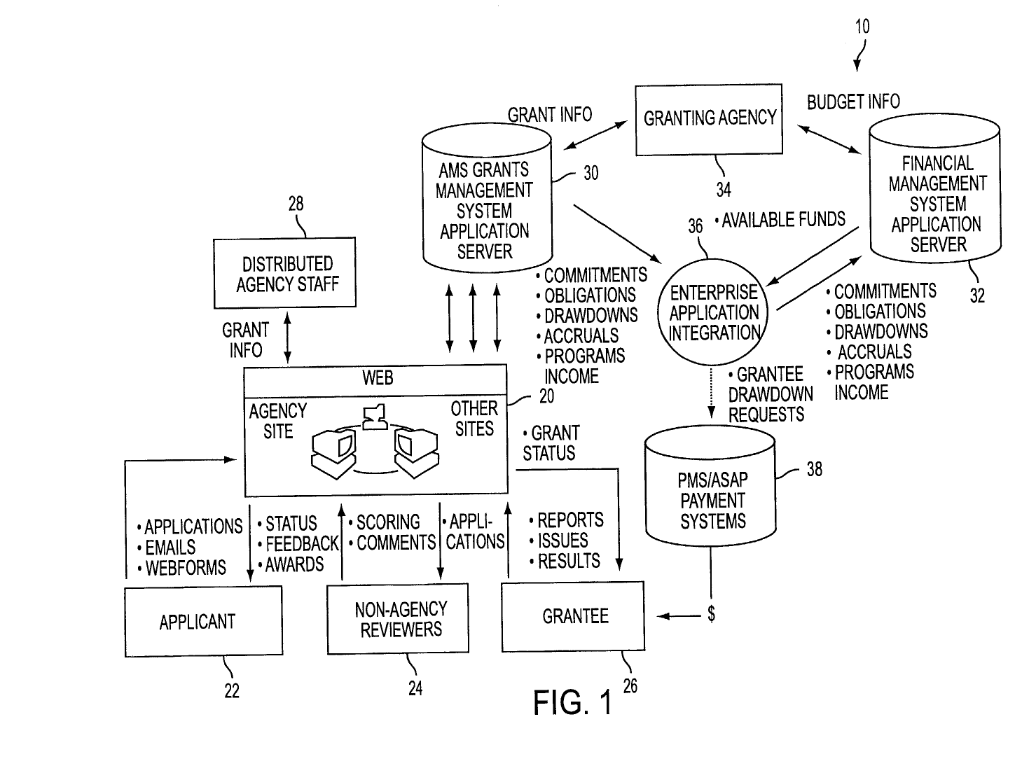

FIG. 1 is a schematic diagram of an embodiment of a MGMS 10 including a Web server 20 connected to a Web portal allowing multiple users, such as applicants 22, non-agency reviewers 24, grant recipient or grantees 26, and distributed granting agency staff 28 (i.e., staff members at remote locations from the granting agency), to access most current information in the MGMS 10, such as applications, e-mails, web forms, status of pending applications, feedbacks awards, scoring, comments, reports, issues, results, and/or grant status. The applicants 22 are those individuals or agencies applying for a grant initiative.

A Web server 20 delivers an HTML document, or “Web page,” to a Web browser (not shown) when requested. These browsers take a document formatted in HTML, generate its visual display, and perform any associated processing. Internet communications are mainly based upon Hypertext transport protocol (“HTTP”), Common gateway interface (“CGI”), Internet inter ORB protocol (“IIOP”), and Java database connectivity (“JDBC”). HTTP is the main communication mechanism among web browsers and servers.

A grants management system application server 30 (“grants management system”) is operatively connected to the web server 20, a granting agency 34, and a financial management system application server 32, to be later described. The grants management system 30 includes multi-channel coordination and communication capabilities allowing the granting agency 34 to interact with users, such as the applicants 22, the grant reviewers, grants managers, financial managers, the grant recipient or the grantees 26, distributed agency staff 28, and other partner organizations over many different communication channels (e.g., telephone, e-mail, fax, web, or in person) and to consolidate all the interaction information so that it is available to whomever needs the information within the granting agency 34. The grants management system 30 may be hosted at a site owned by a proprietary owner such as AMERICAN MANAGEMENT SYSTEMS, AMS of Fairfax, Va. The grants management system 30 also includes permanent or removable storage, such as magnetic and optical discs, RAM, ROM, etc. on which the process and data structures of the present invention can be stored and distributed. The grants management system 30 also includes a processor such as a microprocessor or a like integrated circuit, running an operating system, such as, Windows.RTM. The interactions are uniformly managed regardless of the chosen channel, reducing administrative overhead and the associated headache, improving the efficiency of the granting agency 34, and increasing grantee satisfaction.

The MGMS 10 provides for real-time integration between the grants management system 30 and a financial management system application server 32 such as MOMENTUM, a system provided by AMS, to automatically manage grant initiative transactions and financial transactions associated with a life-cycle of a grant initiative by automatically triggering events including an initiative setup process, a pre-application and an application process, a reviewer assignment process, a review and ranking process, a grant initiative selection process, a requests of grants financial activities process, an information transfer process, and a financial close out process. Management of the grant initiative transactions and financial transactions would include managing the grant initiative transactions and financial transactions associated with the life-cycle of the grant initiative. Automatic or dynamic management of the grant initiative transactions and financial transactions may be accomplished by generating in real time or in an automated manner using a computer processor. The application for a grant initiative, financial assistance, or grant program may include an objective statement from the granting agency 34, restrictions, and eligibility requirements. See Appendix A. The grant initiative's life-cycle includes pre-application, grant publication, application intake, application review or assessment, grant award, grant administration, and grant closeout, of a financial assistance process. See Appendix B.

The financial management system application server 32 (“financial management system 32”) controls the budget for the grant program and receives commitment, obligation, expenditure, and accrual information from the grants system. Specifically, the financial management system 32 includes financial information, which includes commitment, obligations, and expenditures, explanation of the grantee's needs and objectives, and cost and projections of the grant program. The financial manager ensures that the award process and the ensuing financial maintenance of grants are properly handled. The financial manager assumes final responsibility for the allocation of funds to grantees. See Appendix C. The grants management system 30 also includes permanent or removable storage, such as magnetic and optical discs, RAM, ROM, etc. on which the process and data structures of the present invention can be stored and distributed. The grants management system 30 also includes a processor such as a microprocessor or a like integrated circuit, running an operating system.

There are a number of ways to access the MGMS 10, for instance, through a thin client (not shown) or via the Web server 20 or through a desktop application via the Web server 20, which is usually the applicant 22 who is applying for a grant or the non-agency reviewer 24. The thin client, for instance, would be connected straight into the grants management system 30 and the financial management system 32. The grant reviewer may be internal to the agency, or may be a non-agency grant reviewer 24 at a remote location. At either location, the grant reviewer may review the application via the thin client, the Web server 20, or the desktop application. Distributed agency staff 28 may also access the grants management system information from remote locations via the Web.

The grants management system 30, an online portion of the MGMS 10, uses as its nucleus the Siebel eService module. This module is accessible to all users who have the eService entitlement as part of their agreements. A user's login and password are associated to their particular organization; thus, the system pulls up only the information for that organization. No two organizations will have the same list of initiatives, applications, activities, and requests.

On the back-end, the grants management system 30 uses conventional Enterprise Application Integration (“EAI”) tool 36 to communicate in real-time with the financial management system 32 and other agency-critical applications. EAI tools 36 are essentially middle-layer software applications integration units that provide features to allow organizations to integrate different systems quickly using industry standard protocols. The EAI tool 36 offers a robust tool for integration and interoperability tasks as mapping one system to a defined data schema and sending/receiving messages from one system to another thereby permitting integration between various systems, such as in the present embodiment, integration between the grants management system 30 and the financial management system 32.

The EAI tool 36 often provide out-of-the-box, “no coding” adapters to integrate widely used commercial off the shelf (“COTS”) products. The EAI tool 36 component triggers updates to the financial system whenever an activity in the grants management system 30 has financial significance. Integration between the grants management system 30 and the EAI tool 36 is accomplished using a COM, Active-X, XML, or CORBA interface, and the EAI tool 36 provides data transformation, as well as event monitoring, publishing, and subscription. In an exemplary embodiment, the Web server 20 stands separate from the EAI tool 36 and connected to a Web portal. Alternatively, the EAI tool 36 may include the Web server 20.

A conventional Health and Human Services' Payment Management System (“PMS”) or a conventional Treasury's Automated Standard Application for Payments (“ASAP”) 38, for instance, would receive a notification from the grants management system 30 and the financial management system 32 EAI tool 36 to disburse grant payments. The EAI tool 36 transfers conventionally to the PMS/ASAP 38 the information necessary to set up the grantee's payment account and establish drawdown limits. Alternately, users can set up the grantee's payment account and drawdown limits directly in the PMS/ASAP 38.

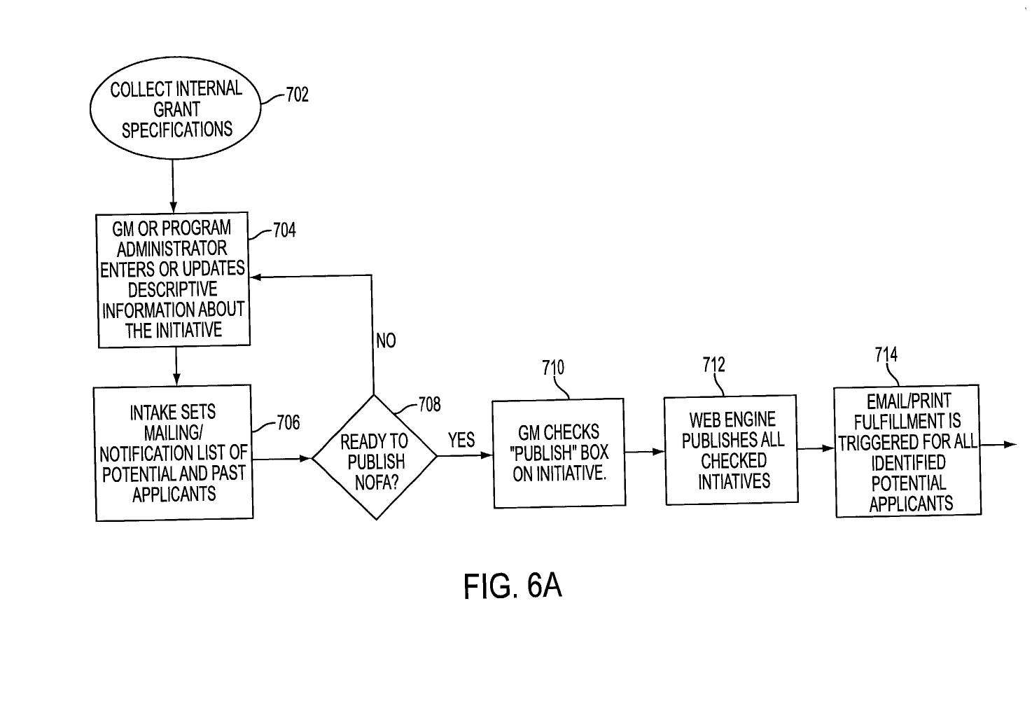

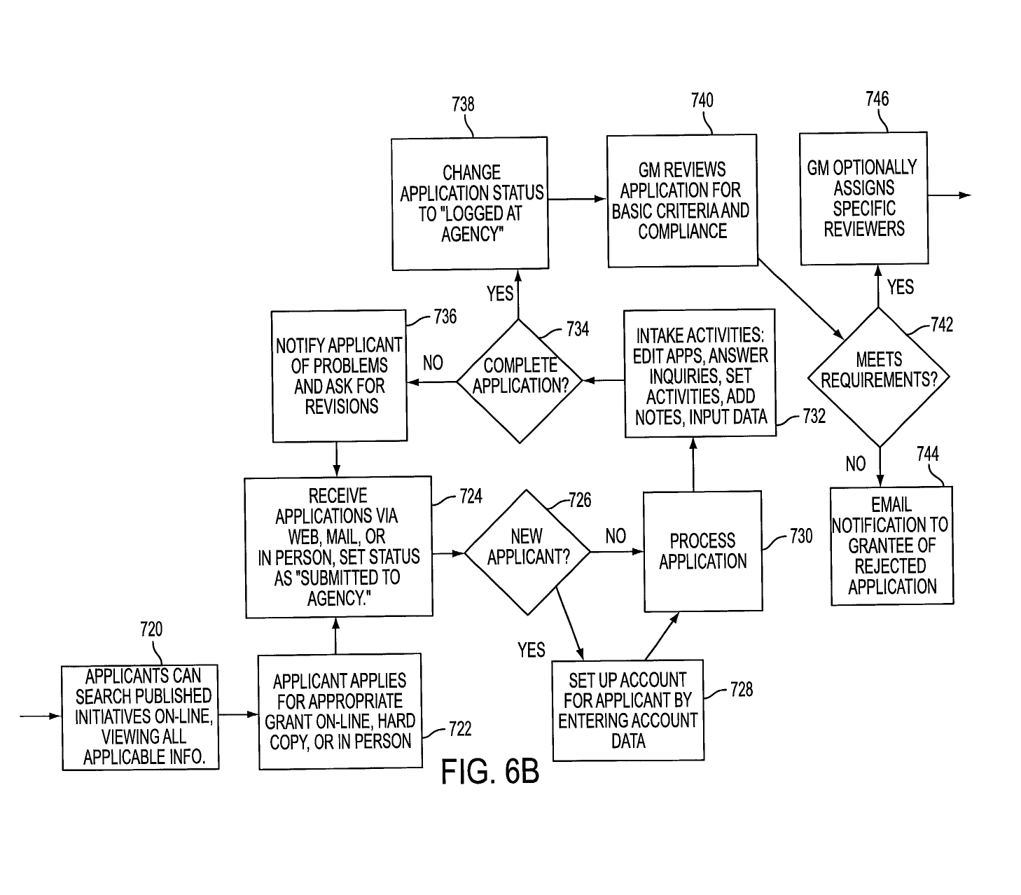

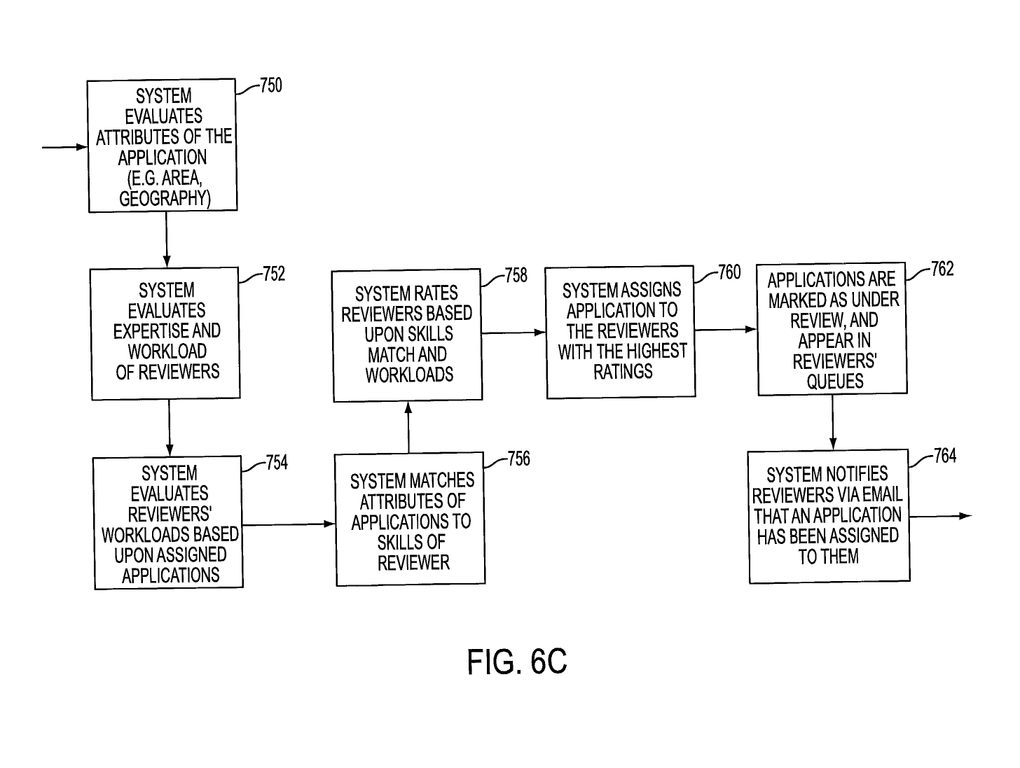

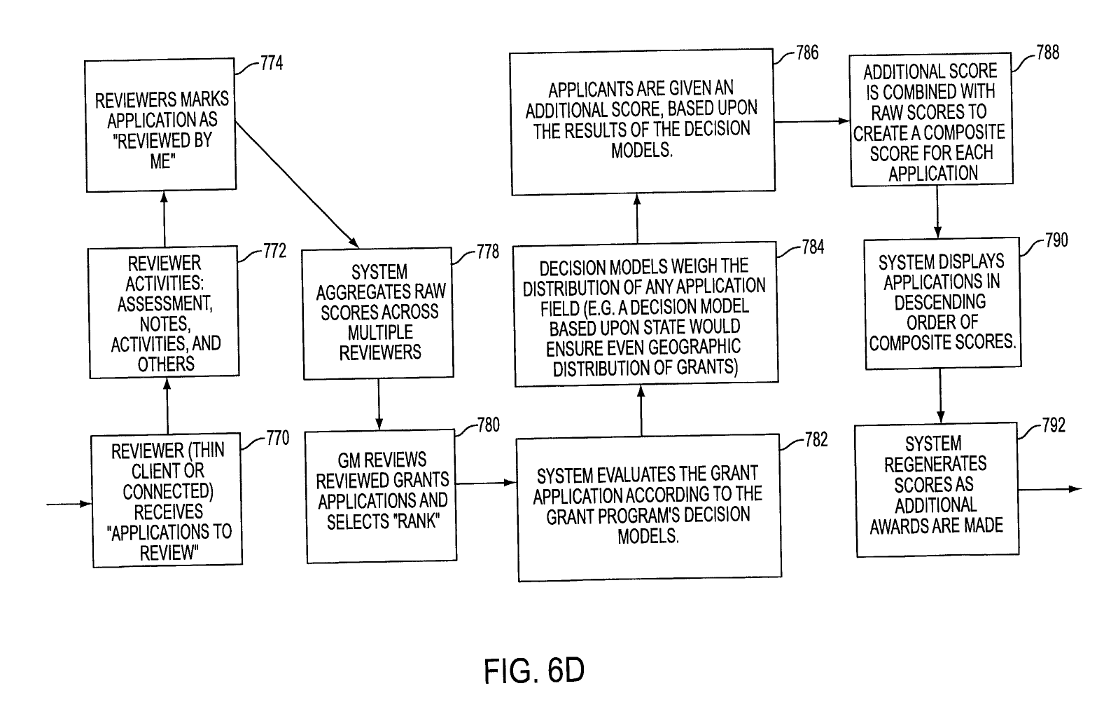

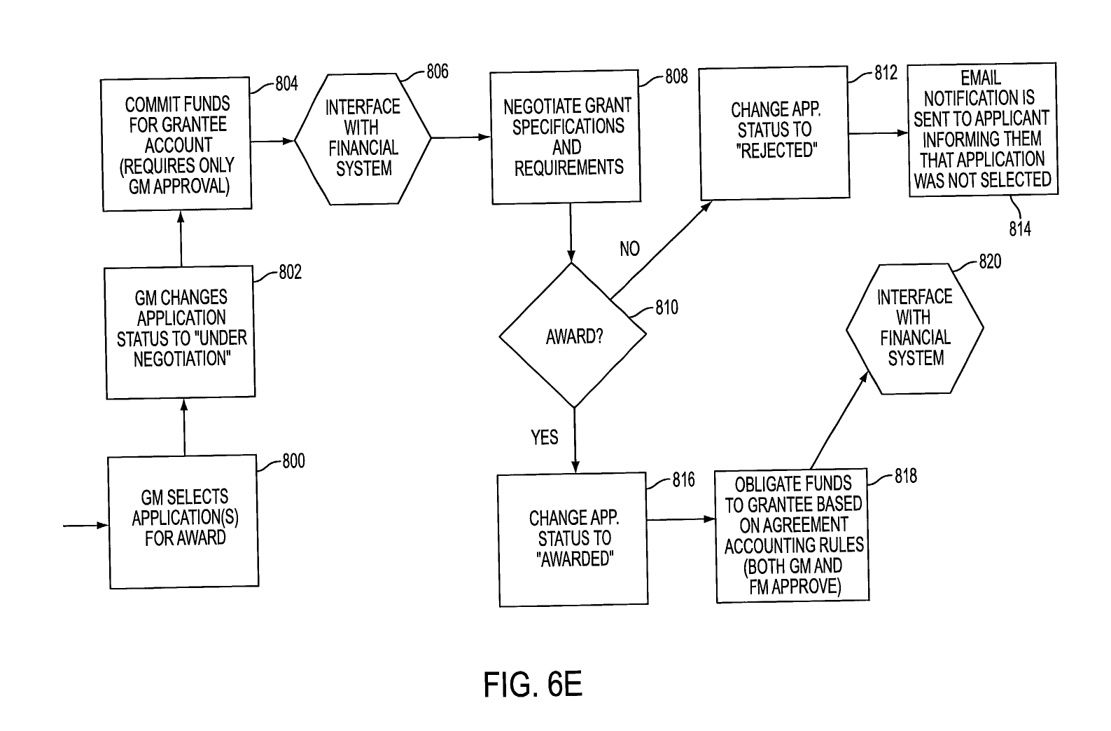

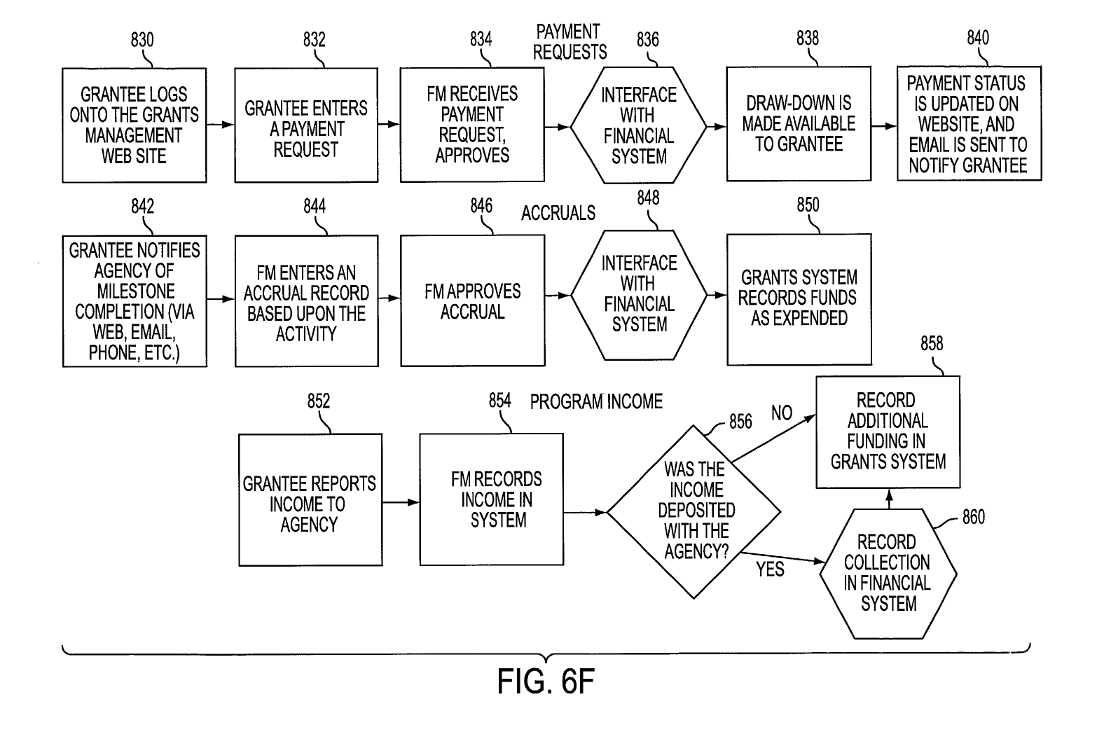

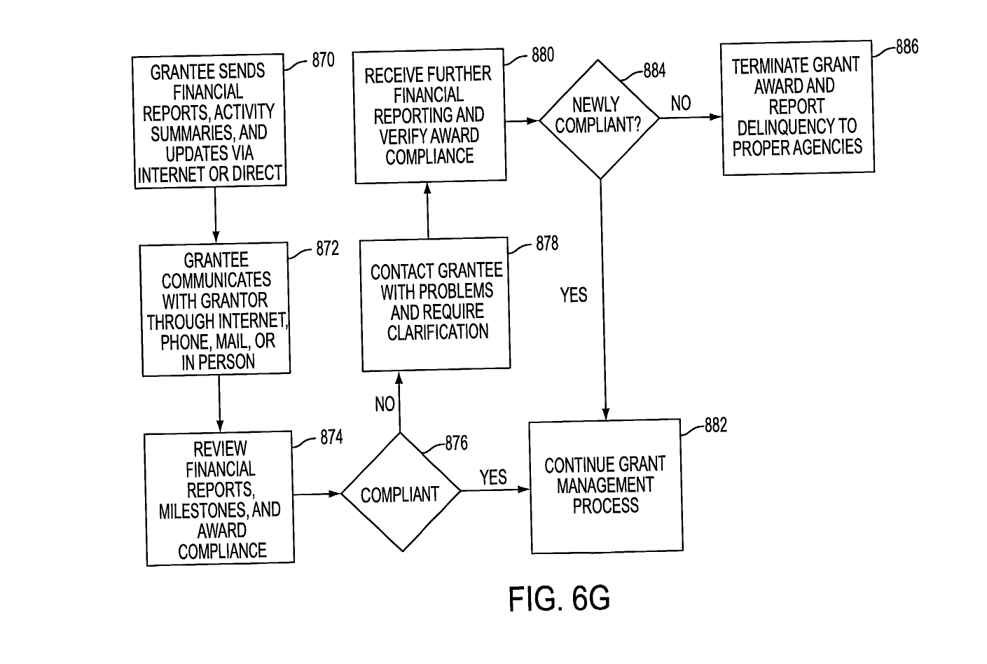

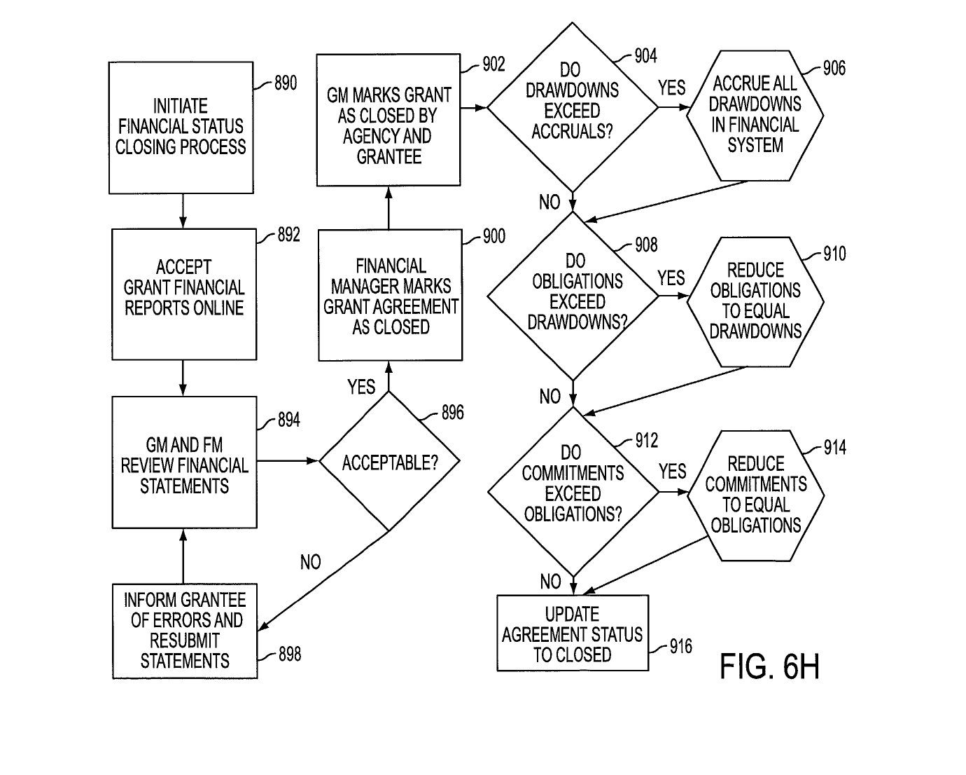

The MGMS 10 provides a single, integrated system that supports the business of grants management by dynamically managing grant initiative transactions and financial transactions associated with the life-cycle of the grant initiative by automatically triggering events comprising an initiative setup process, a pre-application and an application process, a reviewer assignment process, a review and ranking process, a grant initiative selection process, a requests of grants financial activities process, an information transfer process, and a financial close out process, each process to be described in FIGS. 6A-6H. In essence, once a grant initiative has been established in the grants management system 30 from the granting agency 34, the grant initiative can be automatically published to an agency's website with a single mouse-click. Available grants can then be automatically searched and reviewed online by potential applicants 22. The grants manager also has the ability to store in the grants management system 30 e-mail information of potential, or repeat applicants; and automatically notify them of new grant availability via e-mail. See Appendix D.

The applicant 22 can register both his/her intent to apply for a grant, as well as complete grant applications online, through the Web server 20. Questions about a grant application may be submitted via the web page, and standard grants forms may be filled out and submitted in a WYSIWYG format over the Internet. Online applications are edited to ensure completeness and accuracy prior to being accepted, reducing the need to contact applicants 22 for additional information, and increasing the pool of acceptable applications. Online help is available to Internet users, including field-specific “mouse-help” which provides feedback on how to populate fields on the standard grant forms when the mouse passes over the field.

An applicant 22 can check the status of an application online; submit file attachments to supplement his/her application, and schedule meetings with representatives of the granting agency online. All information submitted over the Internet is visible and updateable by the granting agency 34 representatives though a desktop application. This ensures that all grant information, whether submitted electronically or manually, is accessible in a single repository.

Once a grant application is submitted, the grants management system 30 receives the application and dynamically selects a review team to judge the application, based upon the expertise and availability of a pre-defined set of reviewers, and the subject-matter area of the grant. Each reviewer's skills would be predetermined and stored in the grants management system 30. The reviewer best qualified to review the applications for a particular grant would be determined by evaluating the particular grant provided by the grants manager or agency and determining therefrom the skills or qualifications that a reviewer would need to possess to evaluate the particular grant being offered.

Specifically, a potential reviewer is associated with a set of skills, which correlate on a 1-1 basis to the grant focuses. In addition, the total number of applications he/she is assigned measures a reviewer's workload. When assignment of a grant occurs, the grants management system 30 compares each reviewer's skills to the grant focuses on the application. A match between the reviewer's skills and the grant focuses on the application increments the reviewer's score. In addition, the reviewer's workload is factored into his score, based upon a user-defined formula. A score is calculated for every reviewer for each application, and the application is assigned to the reviewers with the highest scores.

The reviewer views all attachments, notes, and performs all activities assigned to the application to make an evaluation of whether to award the grant to the application. Several reviewers are assigned the same application to ensure an unbiased assessment of the application. The scores of the multiple reviewers are then averaged together to get an average score. Automatic review assignment may be turned off, or overridden by an authorized grants manager. See Appendix E. For instance, if the application is in the field of bio-medics, the grants management system 30 would direct the application to be reviewed by a professor specialized in bio-medics.

Furthermore, when reviewing the grant initiative application, multiple reviewers or experts working for the granting agency 34 or grantor need to consider, evaluate, and rank each grant application for a particular grant initiative. The reviewers may review different grant applications for the same grant program and/or cross-programs. Typically, the reviewers may be members of the granting agency 34 (i.e., direct employees of the granting agency 34) or non-agency reviewers who would be reviewing the applications from a remote location, such as professors. The MGMS 10 allows that the applications be reviewed remotely by the non-agency reviewers. Thus, rather than require that all the reviewers evaluating an application be located at a central location, the MGMS 10 provides for a remote and collaborative environment allowing multiple reviewers to assess the applications in a timely, consistent, and efficient manner. A review manager coordinates the application review phase. Applications must be routed to appropriate reviewers, assigned activities, and returned as reviewed applications. The Review Manager is responsible for the Review Teams. See Appendix F.

The reviewers would evaluate each application independently making their assessments, recommendations, and scoring on an individual basis. During the assessment, evaluation, or review of the applications for a particular grant initiative, the reviewer uses standardized decision rules based evaluation criteria provided by the granting agency 34. A grants manager entering or updating information about a particular grant in the grants management system 30 server enters or updates the decision rules provided by the granting agency 34 to distribute grants awards evenly based upon required attributes of the application. Decision rules are rules that the granting agency 34 deems important when assessing and awarding the grant, which are entered and stored in the grants management system 30. These decision rules vary between granting agencies and the data fields in the grants management system's 30 database would be modified accordingly. The grants manager coordinates the grants process from the pre-application stage, through assessments, to the award stage. The grants manager is responsible for the application manager, financial manager, ongoing support, and review manager. For example, a decision rule could be implemented based upon the Congressional District to ensure even distribution of grant awards across all congressional districts. See Appendix G.

Furthermore, once the reviewer logs in the grants management system 30 to find the applications that he or she has been assigned to review, the reviewer has the flexibility of conventionally downloading the application information into his or her personal computer and work off-line, for instance if the reviewer is on a plane. Once done, the reviewer would load the information back into the grants management system 30.

Specifically, after the reviewer assesses and scores the application, the grants management system 30 receives the scores from the reviewers and processes all the scores from all the reviewers together for a final review. The grants management system 30 would then process all the applications for the grant by assessing and scoring their relative merit using the decision rules and combining the reviewers' scores with the scores given by the grants management system 30 to determine which applicant is best qualified for the grant. The grants manager would view all the applications, their corresponding scores, and the applicants that were chosen by the grants management system 30 to be best qualified.

The grants management system 30 has a quantitative objective scoring based on the decision rules, where once each reviewer assigns a score for a particular section(s) of the application or the application as a whole, the grants management system 30 may be customized to take an average of the scores from the reviewers to come-up with a score for either each specific section of the application or the entire application. The objective scoring of the grant application can be performed online, and the granting agency 34 can define the scale and relative importance of each evaluation criteria. In addition, attachments, such as Word processing documents or spreadsheets, may be automatically stored in the database and associated with a reviewer's evaluation.

Also, subjective information can also be recorded in free-text fields associated with each reviewer's evaluation. Specifically, the grants manager may make a subjective determination and conclude that other applicants should also be awarded part of the grant. For instance, if the grants manager considers that a particular applicant has good record of achieving past grant's objectives, the grants manager may take this factor into consideration when awarding the grant. Thus, the grants management system 30 allows for objective and subjective determinations when awarding grant initiatives. The grants management system 30 is efficient and effective by assuring that the applications are assessed using the same set of criteria.

All grant application information stored in the system, as well as information added by the reviewer, is accessible to authorized grants reviewers and administrators through a standard TCP/IP connection to the main system. If connectivity is not possible (for example, on an airplane) the system will replicate only the data that a user has authority to view to a local database, which may be accessed, updated, and then re-synchronized with the central system.

Once an award decision has been made, the grants management system 30 automatically passes appropriate accounting information to a financial system 32, to be later described. This includes generating commitments and de-commitments, obligations and de-obligations, advance payments, accruals, and collections as appropriate. Templates, which correspond to a specific accounting distribution, are used to simplify accounting data entry for program officials. The grant amount awarded may be updated after the financial management system 32 has approved the original grant. The grants management system 30 would automatically amend the grantee's information to include an amendment indicating the revised grant amount.

Once an award has been made, the MGMS 10 continues to manage interaction with the grantee 26. This includes support for online submission of standard forms, such as records of financial status as well as ad-hoc documents, such as monthly status reports. In addition, the MGMS 10 allows both the grantee 26 and representatives of the granting agency 34 to schedule meetings, record milestones, and keep notes associated with the project via the Web server. All grantee interaction with the MGMS 10 occurs over the Internet, while members of the granting agency 34 may access the system over the Internet, or via their desktop application.

Further, the grants management system 30, via the EAI tool 36, may direct the PMS/ASAP 38 to fulfill standard grantee requests, such as payment requests submitted in person, over the Internet, or via e-mail. This includes automated interfaces with the granting agency's 34 financial management system, the payment disbursement system, and feedback to the grantee 26 on the status of a payment request via e-mail and the web.

After the grant has expired or the period of performance outlined in the contract between the granting agency and the grantee expires, there are a number of processes, which must occur prior to closeout of the grant. These are both procedural and financial in nature. The grants management system 30 automates the standard forms and filing associated with grant closeout, and automatically generates the appropriate deobligations and decommitments to return any unused funding to the granting agency's 34 budget, to be later described.

Within the MGMS 10 there are numerous responsibilities that must be executed by the appropriate positions. For example, only a financial manager can make decisions on withdrawal requests made by grantees. To maintain the integrity of the system, each user receives a login and password that limits their access to the screens, views, and fields necessary to accomplish their responsibilities. See Appendix I.

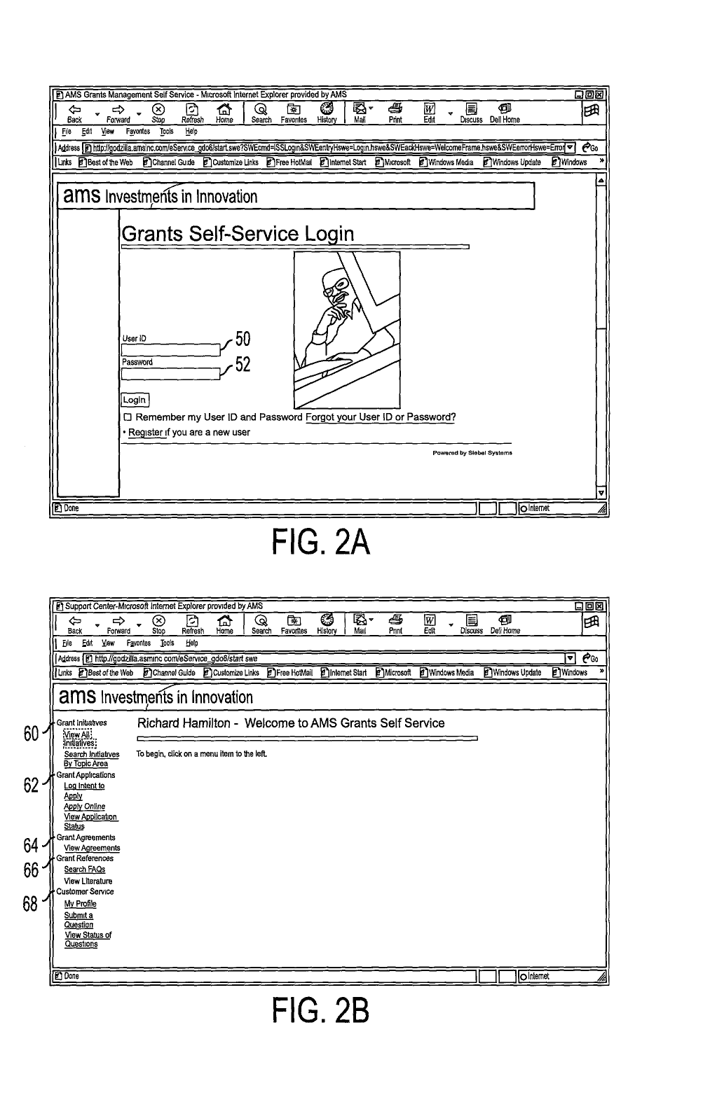

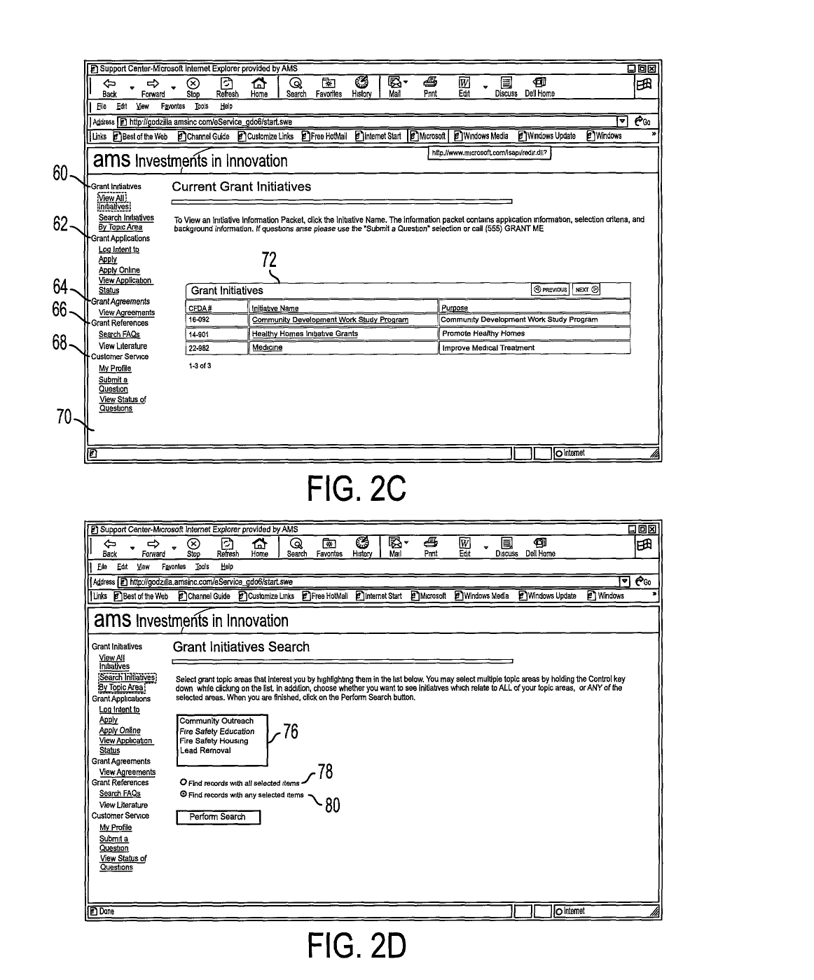

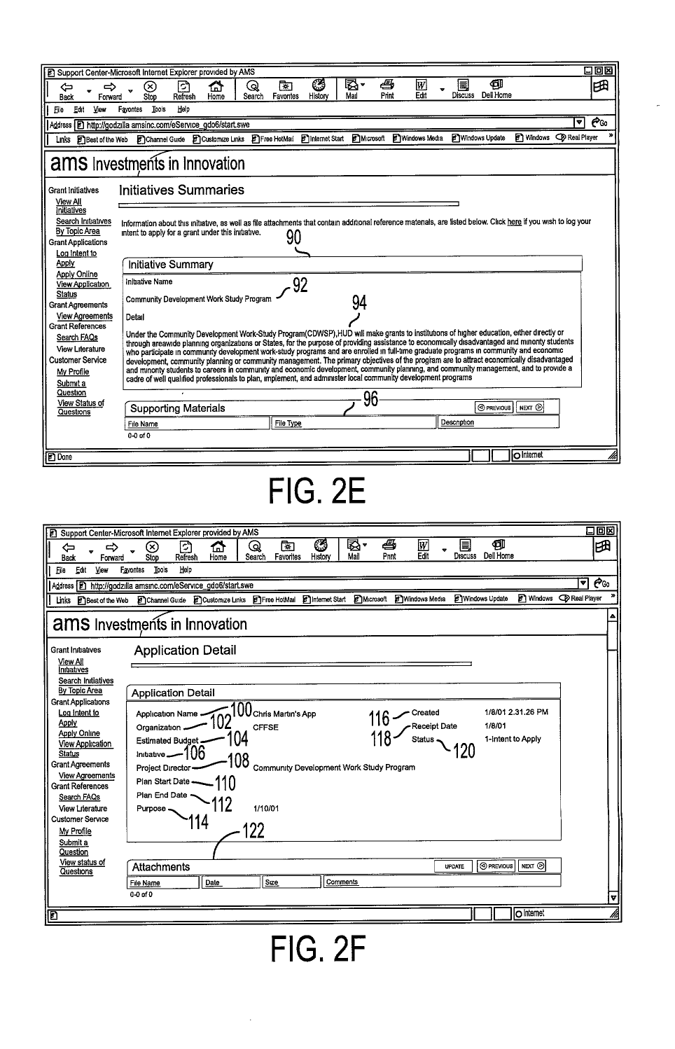

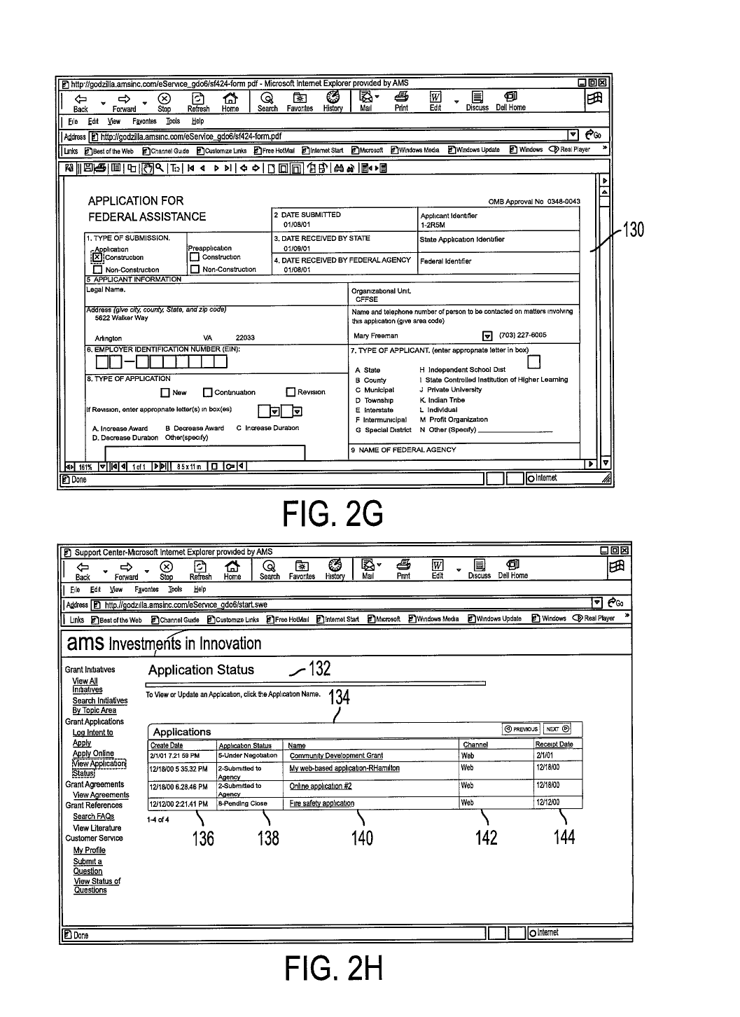

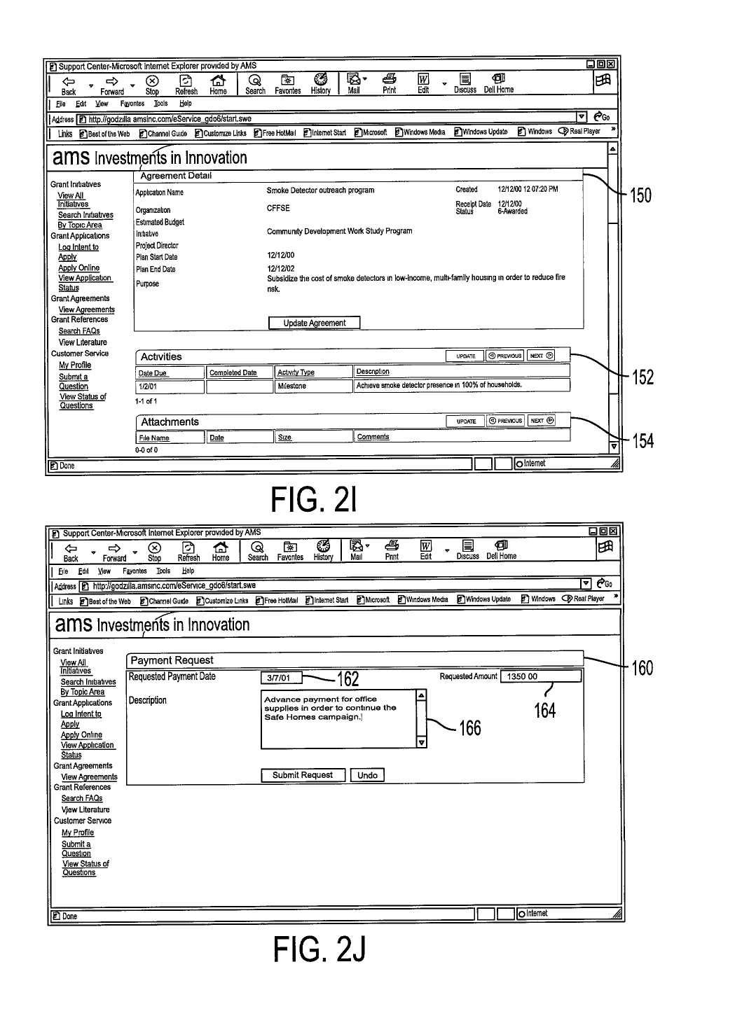

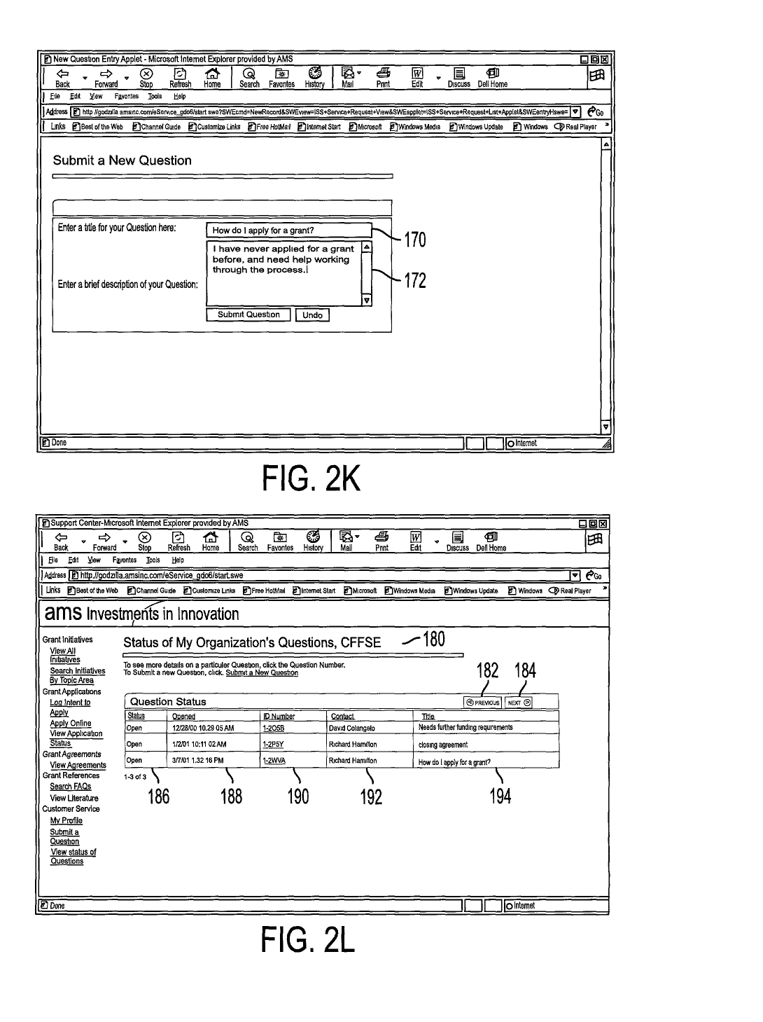

FIGS. 2A-2L show grantee/applicant web access graphical user interface screens displayed, for instance, via the Web server 20 and generated by the grants management system 30. See Appendix J. Those fields in the screens that follow that are not described in detail are generic fields from the underlying CRM tool that are not used by the MGMS 10 but can be customized to meet the needs of the users. More particularly, FIG. 2A shows the grantee/applicant web-access login screen where, once registered, the applicant logs into the grants management system 30 using a User ID 50 and password 52. FIG. 2B shows a grantee/applicant self-service main menu providing access to all applicant functions such as grant initiatives 60, grant applications 62, grant agreements 64, grant references 66, and customer services 68. FIG. 2C shows all initiatives 72, which lists all published grant initiatives and objectives available to the applicant. See Appendix AD. On a left side of the screen, a navigation bar shows the different screens the applicant may access. Specifically, the applicant may view the grant initiative screens 60, where all the initiatives available may be viewed and searches by topic area may be performed. See Appendix T.

The navigation bar also shows the grant application screens 62 where the applicant may apply for a grant initiative and/or view the status of a pending application. See Appendix M. The grant agreement 64, grant reference 66, and customer service screens 68 may be also viewed. See Appendices X, Q, and R. FIG. 2D shows a web-screen where the potential applicant may search grant initiatives by topic area 76, i.e., based upon the subject area. See Appendix K. The applicant may select multiple topic areas. Further, the applicant has the option of finding records with all the selected initiatives 78 or finding records with any selected initiative 80.

In addition, the screen could be designed to allow the applicant to track the granting agency 34 grants history, view the agency's entitlements, and enter new activities or updates concerning the granting agency 34. Maintaining up to date, reliable, and easily accessible data on granting agencies that have past grant soliciting history, is vital to the efficiency of the granting agency's 34 initiatives.

FIG. 2E shows a grant initiative summary 90 of the grant initiative searched and/or selected by the applicant. The screen provides for the grant initiative name 92, summary 94, and any other supporting materials 96 or attachments such as documents, figures, spread sheets, forms, etc. FIG. 2F shows an online application detail screen including application name 100, organization 102, estimated budget 104, initiative 106, project director 108, plan start date 110, plan end date 112, purpose 114, created 116, receipt date 118, and status 120. The applicant may incorporate attachments 122 to the application.

FIG. 2G shows an online application screen displaying the application forms, which are standard application forms, in WYSIWYG format 130, automatically updated with current application information. See Appendix M. The screen shows the actual form that the applicant would need to fill out to apply for the particular grant or initiative. The form may be either completed directly online or may be printed out. Thus, the grants management system 30 incorporates the fields in an application for federal assistance, for instance, and provides the granting agency 34 and the applicant or the applicant's agency with the ability to see the actual form online thereby making it easier for the granting agency 34 to review the application and for the applicant to fill out.

The grants management system 30 would automatically incorporate information already in the system regarding the applicant such as name, identification number, address, organization unit or number, etc. Further, regarding contacts information for the particular application, if there were more than one contact at the applicant's agency, the grants management system 30 would provide for a pull-down menu listing all the known contacts. See Appendix N. The applicant would then choose the contact from the list provided. Further, the grants management system 30 would provide for a list of individuals at the applicant organization that have signatory authority to apply for the grant initiative and sign the application. The grants management system 30 would also include a section (not shown) on the screen to support an electronic signature from the applicant.

FIG. 2H shows a view application status 132 screen of the current status of all the applications 134 submitted by the applicant or the applicant organization. The application 134 may be reviewed or updated by clicking the application name 140. Further, the date the application was created 136, application status 138, and the receipt date 144 of the application by the grants management system 30, and the channel 142 that was used to file the application are also shown.

FIG. 2I shows a view of details of an approved grant agreement. The details include “Agreement Detail” 150, “Activities” 152, and “Attachments” 154. The upper frame of the screen displays the details of the agreement 150 of the grant awarded to the applicant. The middle frame includes “Activities” 152, which displays milestones that need to be met, such as submission of additional information. Here, the applicant can also note whether a meeting is required with the grants manager, program administrator, or by a particular reviewer about a specific of the application. The program administrator or application Manager assumes responsibility for the intake process. This position requires access to all applications and all granting agencies to handle the intake process. Updating granting agency information, reviewing applications for missing information, and creating activities to be conducted, are the primary actions of this position. See Appendix O.

Thus, the “Activities” 152 portion of the screen ensures that there are continuous updates of the application process to the applicant and that communication between the applicant and the reviewers or grants manager is maintained. The lower frame illustrates “Attachments” 154 where, if during the process of filing or assessing an application, the applicant may include additional documents or other information that the applicant would like the reviewer to consider when reviewing the application. FIG. 2J illustrates the requests drawdown screen where the applicant may request a payment 160 from the granting agency 34 specifying date 162, amount 164, and purpose 166 of the payment. FIG. 2K shows a help screen allowing grantees to submit title 170 and description 172 of online questions to the granting agency 34. See Appendix P. Further, the screen may display a list of frequently asked questions or facilitate the applicant to search from the list of frequently asked questions. See Appendix Q.

FIG. 2L shows a review status screen of the question presented 180 by the applicant to the granting agency 34. See Appendix R. The previous/next buttons 182, 184 allows the applicant to review the status of other questions presented by the applicant or the applicant organization to the granting agency 34. See Appendix S. The screen would also provide a status of the question 186, a date 188 the question was reviewed by the granting agency 34, an ID number 190 a contact name 192 of the person assigned to provide an answer to the applicant, and title 194 of the question. See Appendix AE. The telephone number of the contact person is also provided allowing the applicant to contact the person directly if needed. The applicant may submit attachments and/or updates. The contact person may also submit attachments and/or updates with an answer to the question presented.

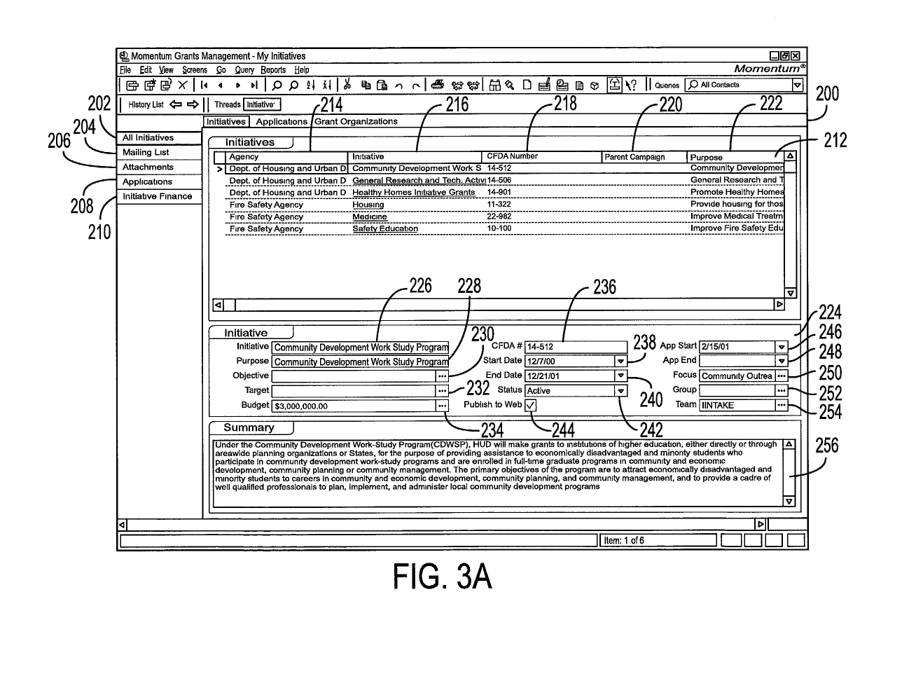

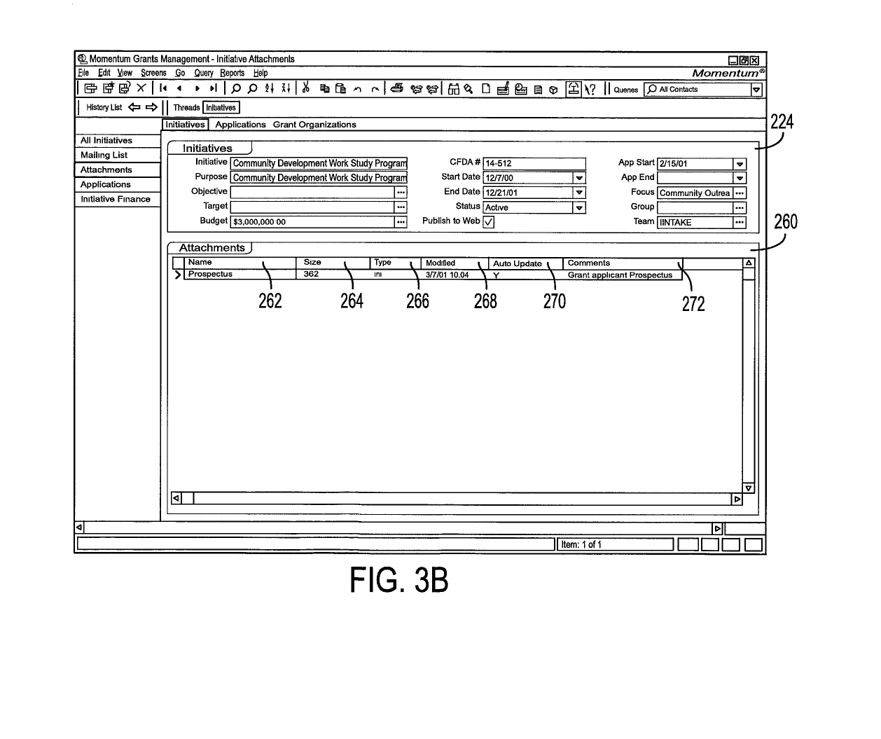

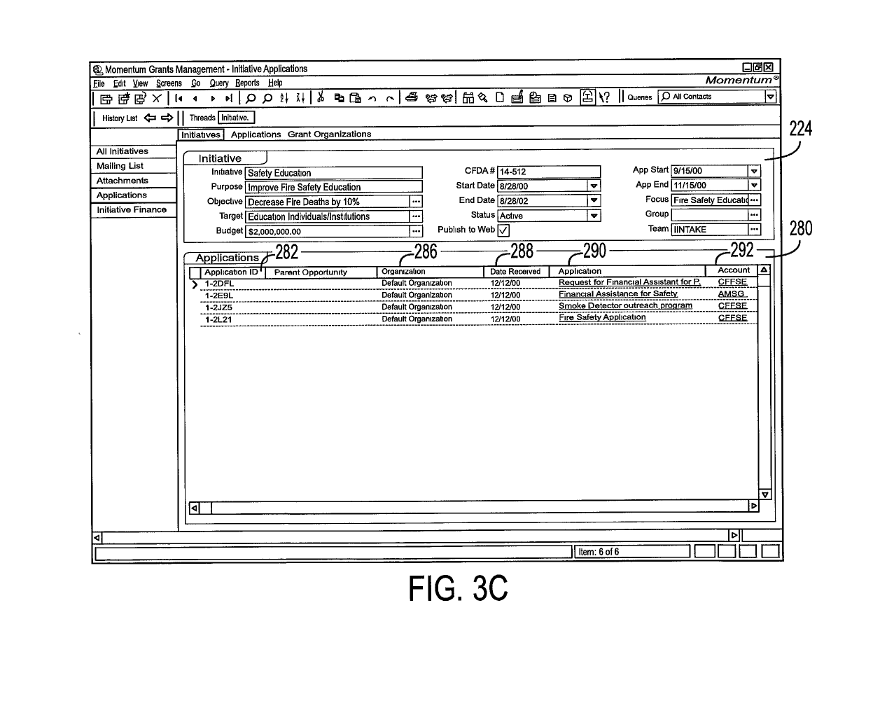

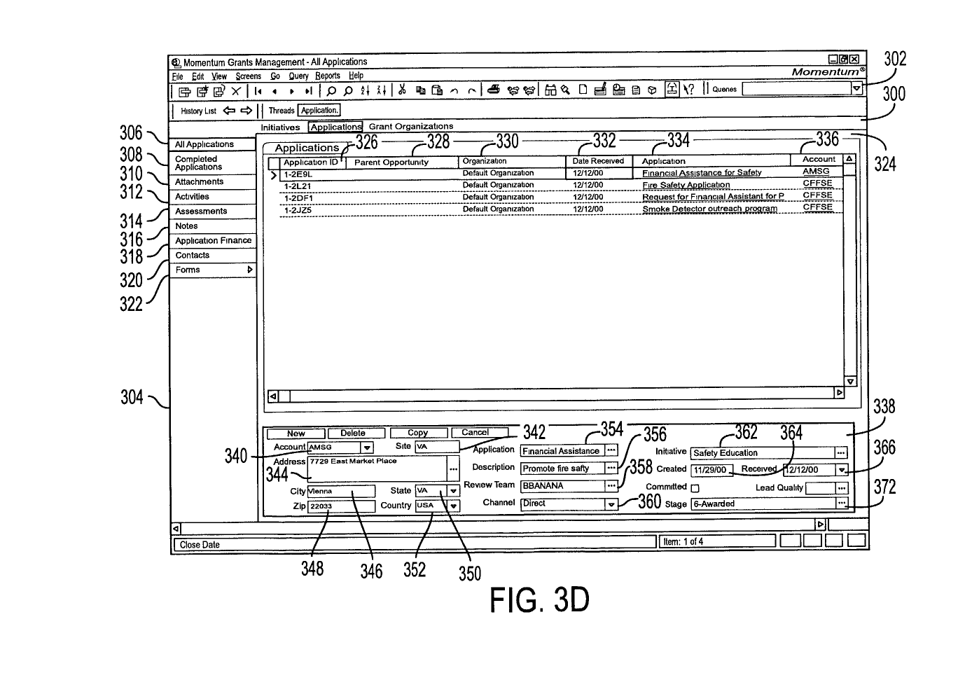

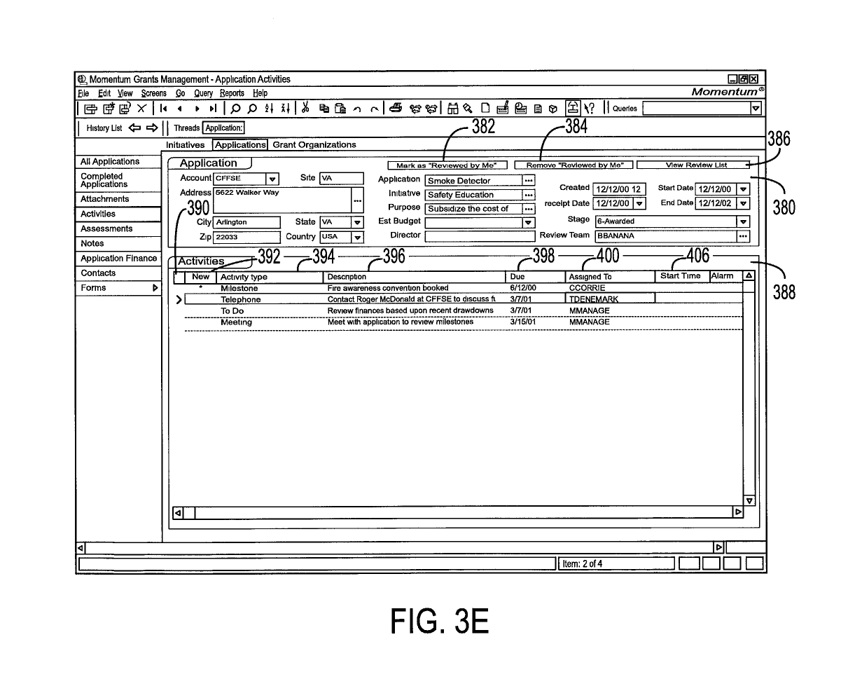

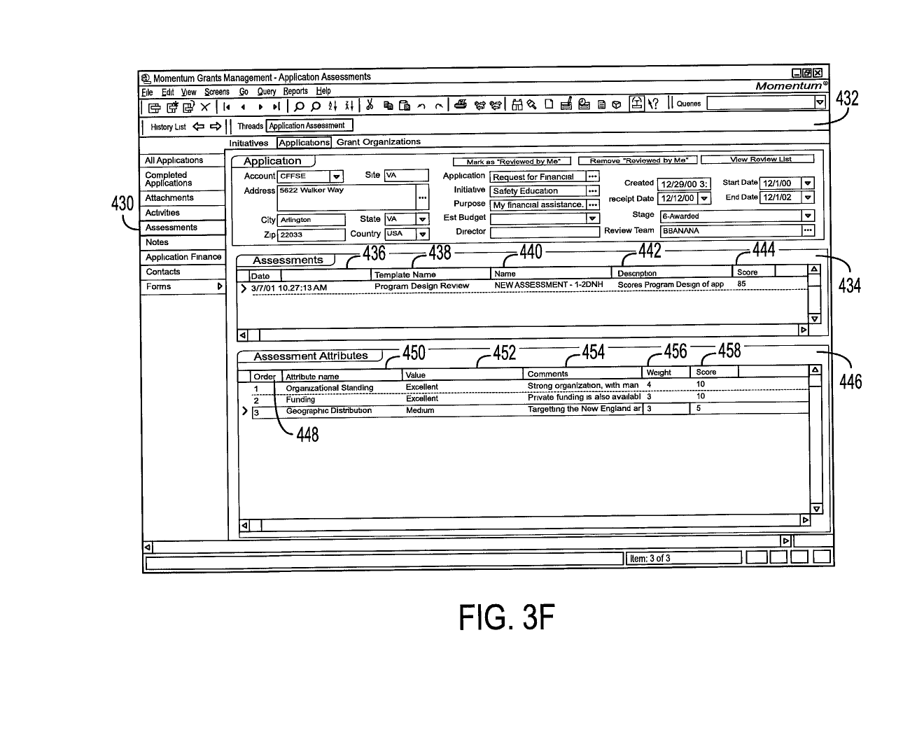

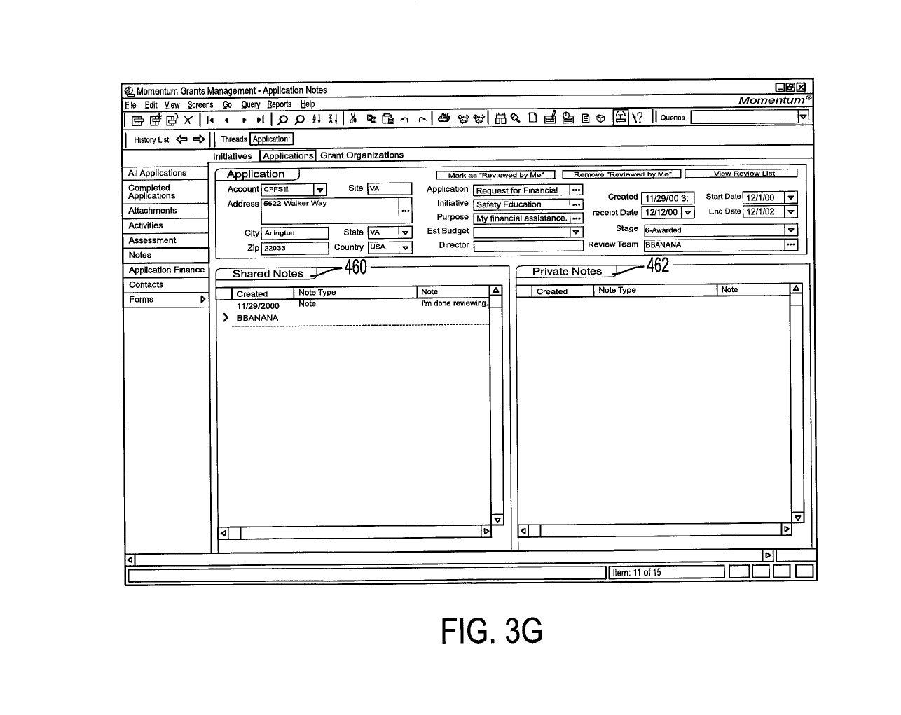

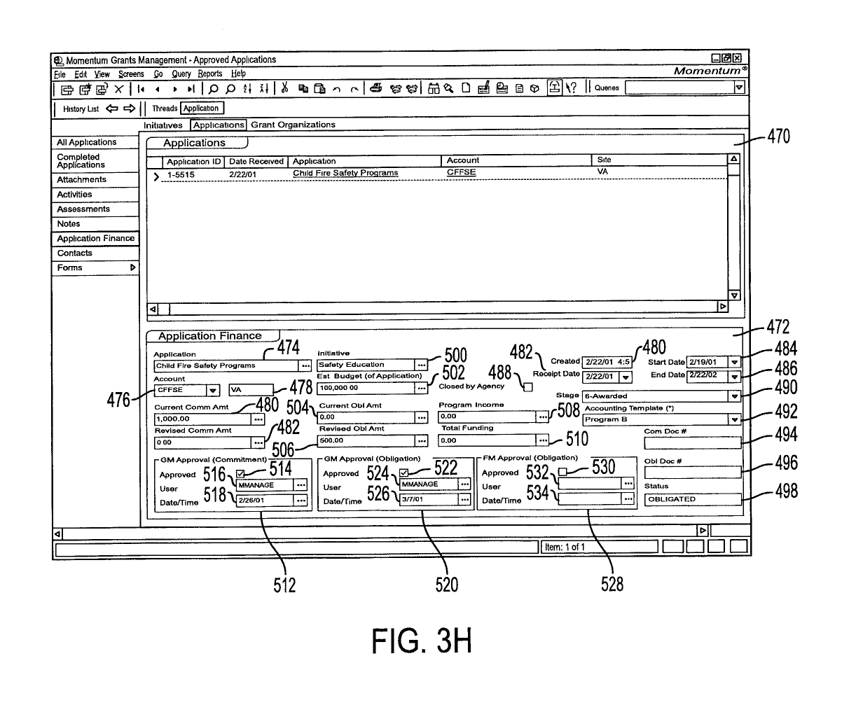

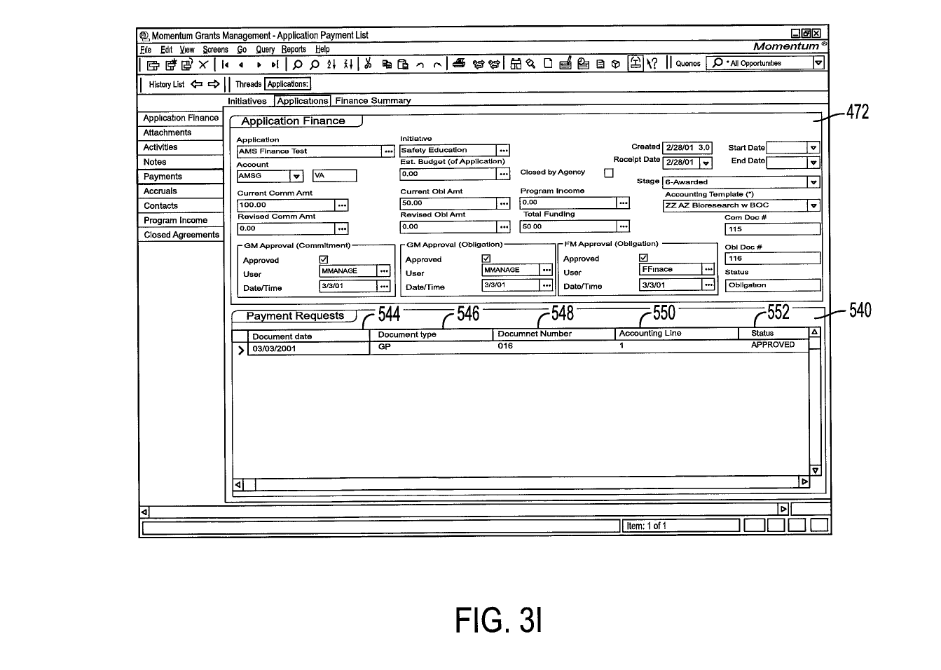

FIGS. 3A-3C are grant initiative graphical user interface screens where the grants manager or a program administrator at the granting agency 34 enters new grant initiatives. See Appendix T. These screens are accessible only by either the grants manager or the granting agency 34. The applicant or grantee does not have access to these screens. FIG. 3A shows an initiative entry view. A toolbar 200 is shown in the top of the screen containing buttons with images, menus, or a combination of both. Further, a title bar displays “Initiatives,” “Applications,” and “Grant Organizations.” Each represents a group of screens that are part of the life-cycle of the grant initiative. Because the present screen is an initiative screen, “Initiatives” is highlighted. The “Initiatives” screens guide the grants manager, for instance, to input attributes pertaining to each initiative, to update the attributes, and to keep track of the status of applications for each grant initiative. The “Applications” screens are a group of screens where the applicants or grantees access available grant initiatives, apply for a particular initiative, and keep track of the status pertaining to their applications. The “Grant Organizations” screens show all the applicants or grant recipient organizations with which the granting agency 34 interacts.

On a left side navigation bar 202 of FIG. 3A, various grant initiative screens are listed which are “All Initiatives” 202, “Mailing List” 204, “Attachments” 206, “Applications” 208, and “Initiative Finance” 210. “All Initiatives” 202 is highlighted. See Appendix U. The right portion of the web screen is divided into three frames, an upper frame, a middle frame, and a lower frame. The upper frame shows all the grant initiatives available. Specifically, the upper frame lists all published and unpublished grant initiatives. A title bar 212 shows “Agency” 214, “Initiative” 216, a CFDA Number 218,” “Parent Campaign” 220, and “Purpose” 222. The agency 214 is the granting agency 34 offering the particular grant initiative. Initiative 216 is the name or type of grant initiative published or unpublished. The CFDA number 218 is the Catalog of Federal Domestic Assistance Number. The parent campaign 220 initiative identifies a relationship between various campaigns. Purpose 222 specifies the type of applicant, the purpose of the grant, the objective, and/or other particulars that the grants manager deems important.

The middle frame shows multiple data fields of the initiative 224 selected or highlighted on the upper frame. The grants manager or the particular granting agency 34 offering the grant initiative defines the data fields for each initiative. The data fields provided by the grants manager or agency are to be processed by the grants management system 30 to determine therefrom the reviewers that would be best qualified to review applications for that particular grant, to be later discussed.

For each grant, the grants manager would enter the data fields, each depending on the particular grant. Some of the text windows may be pull-down lists from which the grants manager would select from the list provided depending on the particular grant. The applicant would not have security access to modify the data fields displayed in the text windows.

Further, the applicant may perform online searches using the data fields. For instance, the applicant would go online and make a query asking for a list of grants with housing and safety education initiatives. The applicant may use one or more data fields when performing the online search.

Some examples of the data fields that may be displayed are an initiative text window 226 displaying the name of the particular selected grant initiative and a purpose text window 228 displaying the purpose of the grant. An objective text window 230 would display the objectives the grants manager wishes the applicant to achieve with the grant funds. A budget text window 234 shows an amount of funds available in the grant initiative. The CFDA text window 236 shows the Catalog of Federal Domestic Assistance Number for the grant selected. A start date text window 238 and an end date text window 240 display the starting and ending dates of the grant offering. A status text window 242 displays the current status of the application.

A “Publish to web” check box 244 would be checked if the grants manager authorized the grant to be published to the web. Although this box is checked, the grants manager may access and update the grant information. Once the grants manager checks the box, the grants management system 30 would automatically notify those registered individuals or organizations (as discussed later) and display the initiative information on the Agency's web page.

An application start text window 246 and an application end text window 248 display the application start and end date for submission. Because the status text window displays “active,” which is indicative that the application is in the process of being assessed, the application end text window does not show an end date. A focus text window 250 displays the particular key focus areas covered by the grant initiative, such as community development, general research, health, medicine, safety education, etc. Thus, the grants manager would select from the list the focus of the particular initiative. A team text window 254 displays the group name or group number assigned to review the application.

A lower frame would show summary information 256 about the particular grant selected on the upper frame. The summary 256 may include the procedure as to how to apply for the particular grant, the criteria the grants manager would be considering to award the grant, contact information, etc.

In a “Mailing List” screen (not shown), those individuals or agencies that have registered with the grants management system 30 inquiring into grants for particular initiatives (i.e., community development, housing, or medical) in the past, would receive e-mails or notifications notifying them of the availability of funds for those initiatives. In this screen, the grants manager would input mailing information pertaining to each applicant who has applied in the past or who has made inquiries about specific grants or initiatives and have expressed an interest in applying. The screen would display the last name of the applicants, first name of the applicants, type of initiative or initiatives in which the applicant is interested, work phone, home phone, work fax, e-mail address, mailing address, date/time the applicant's information was entered, a flag indicating whether a notification was sent to the applicant, and date/time the notification was sent to the applicant.

FIG. 3B shows an initiative “Attachments” screen. Attachments are supplemental information for each initiative. The upper frame of the screen shows the data fields of the initiative 224 as described in FIG. 3A. The lower frame shows the attachments 260 provided by the granting agency 34 to the grants manager or the program administrator. The attachments may include documents or spread sheets providing additional information about the grant or additional information provided by the applicant. Further, the attachments may include scanned images or any other electronic file. The attachment would include the name of the attachment 262, size 264, type 266, modified 268, auto update 270, and comments 272. The grants manager may update the attachments before or after the grant initiative is published to the web. The applicant may access a particular attachment 262 by clicking on that attachment 262 and either downloading or opening the attachment. Similarly, during the process of applying for a grant, the grants management system 30 enables the applicant to submit attachments 260, such as project plans and progress reports online. As a result, the grants management system 30 is a dynamic and flexible system that accommodates the attributes, criteria, and supplemental information from an applicant and/or the granting agency 34 necessary to provide in the grant initiative.

FIG. 3C shows the “Applications” screen where all the initiative applications under a specific initiative would be displayed. Here, the grants manager would be able to view all the applications that have been received and entered for a particular initiative. The screen would also display the initiative criteria 224 explained in FIG. 3A for the selected or highlighted application. It may also display information such as application identification number 282, name of the applicant or applicant organization 286, date application received 288, application title 290, account number 292, etc.

FIGS. 3D-3I are grant application graphical user interface screens, which are accessible by the grants manager, the programming administrator, or any member of the granting agency 34. See Appendix V. FIG. 3D shows a main screen or “All Applications” grant screen that the granting agency 34 would view. A title bar 300 displays “Initiatives,” “Applications,” and “Grant Organizations.” A “queries” text window 302 in a toolbar shown at the top of the screen would allow the grantee to do searches. For instance, a member of the granting agency may search for specific initiatives, accounts, grantee, status of a pending application, etc. On a left side navigation bar 304 of the screen, the grant application screens are listed, which include “All Applications” 306, “Completed Applications” 308, “Attachments” 310, “Activities” 312, “Assessments” 314, “Notes” 316, “Application Finance” 318, “Contacts” 320, and “Forms” 322, each to be later described.

In the “All Applications” screen, the right portion of the web screen is divided into two frames. The upper frame shows applications 324 submitted by applicants. The grant applications may be sorted by grant initiative. A title bar includes “Application ID” 326, “Parent Opportunity” 328, “Organization” 330, “Date Received” 332, “Application” 334, which is the title of each particular application submitted by the applicant, and “Account” 336. Account is used interchangeably with the term grant organization. The lower frame 338 shows editing response buttons, such as “New,” “Delete,” “Copy,” and “Cancel.” The lower frame would also show the data fields pertaining to the particular application selected or highlighted in the upper frame. For instance, the account number 340 of each application submitted by the applicant, the site or State (e.g., Virginia) 342 where the applicant or applicant organization is located, “Address” 344, “City” 346, “State” 350 “Zip” 348, and “Country” 352 of the applicant, “Application” title 354, “Description” of the initiative 356, “Review Team” 358 assigned to the application, “Channel” 360, “Initiative” 362, date initiative created 364, date initiative received 366, and the application “Stage” 372. The stages 372 of the application may include, 1-submitted, 2-logged at agency, 3-under review, 4-rejected, 5-under negotiation, 6-awarded, etc. The stages 372 may be modified according to the granting agency 34.

An “Attachments” screen (not shown) 310 would display the toolbar, the navigation bar, and the upper frame including the data fields pertaining to the particular application selected on the “All Applications” screen of FIG. 3D. Additional data fields that may be displayed are “Receipt Date” of the application, “End Date” of the application, “Estimated Budget,” “Director,” and the attributes displayed on the lower frame of the “All Applications” screen. A lower frame on the screen would display file attachments to the application from either the applicant or from the granting agency 34. Thus, during the process of filing an application, the applicant, similar to the grants manager, may include additional documents or other information that the applicant would like the reviewer to consider during the assessment of the application.

FIG. 3E shows a screen displaying application “activities.” See Appendix W. Specifically, the screen shows activities associated with the administration of the application. The applicant also has access to this screen. See FIG. 21. The tool bar 300 and the navigation bar 304 of the screen are the same as the ones described in FIG. 3D. An upper frame 380 on the right portion of the screen displays data fields of the particular application being accessed. Further, the upper frame 380 further shows a “mark as ‘reviewed by me’” 382 and a “remove ‘reviewed by me’” 384, to be later described. A “view review list” response button 386 would show the list of reviewers who had completed their review of this application. If the applicant applies for the initiative either via regular mail, fax or in person, the reviewer receiving the applicant's information would review the application and determine whether the application is complete.

In the lower frame 388 of the right portion of the screen, “activities” related to the application are displayed. A title bar 390 under “Activities” shows “New” 392 (i.e., if the activity is a new activity), the activity type 394, a description for the activity 396, a due date for the activity to be completed 398, and the reviewer assigned to the activity 400, start time of the activity 406, etc. The title bar 390 may be modified to display other information pertaining to the activities. Here, the grants manager makes sure that the application process is moving along and that no further information is necessary from the applicant to proceed with the application process. Also, the grants manager, program administrator, or a particular reviewer can set as a milestone that a meeting is required with the applicant or representative. Thus, this screen ensures that there are continuous updates of the application process and that communication is maintained between the applicant and the reviewers.

A “Contact” screen (not shown) may also be displayed for application contacts associated with the grant application. An upper frame on the right portion of the screen displays attributes of the particular application being accessed, which are the same as those described in FIG. 3E. The “Contacts” screen may display contact information regarding the applicant of the subject application, such as name, work and home telephone number, e-mail address, mailing address, account number, a method preferred by the applicant to be contacted (i.e., telephone, e-mail, or regular mail, fax), etc. The attachments associated with the particular application may also be displayed.

Further, similar to FIG. 2G, a screen would be also shown displaying the application forms, which are standard application forms in WYSIWYG format, automatically updated with current application information. The screen would show the actual form that the applicant filled out to apply for the particular grant or initiative.

FIG. 3F shows an Application Assessment screen, which is an online assessment of the application by reviewers based on granting agency custom-defined templates. Specifically, the screen shows a grant application that is submitted to the Agency for review. The tool bar 300 and the navigation bar 304 of the screen are the same as the ones described in FIG. 3D. Further, the “Assessments” 430 is highlighted in the left column portion of the screen. An upper frame 432 on the right portion of the screen displays attributes of the particular application being accessed as described in FIG. 3E. A middle frame 434 displays the assessment information such as “Date” of the assessment 436, “Template Name” 438, which is the template that has been loaded into the grants management system 30 to be used to review the application, “Name” 440, “Description” 442, and “Score” 444, which is the aggregate score of the attributes assessed as shown in the lower frame, to be later described.

The attributes or fields for each assessment template are programmed corresponding to decision rules that the granting agency 34 deems important when assessing and awarding the grant. These decision rules vary between granting agencies and the data fields in the grants management system's 30 database would be modified accordingly. The decision rules allow the grantor to create and change policies, guidelines, and constraints directly for awarding grants. These decision rules are programmed in the grants management system 30 and are applied to determine therefrom the fields that need to be evaluated by the reviewer and are applied to generate therefrom a overall score for each application. Changes in the decision rules are instantly distributed throughout the grants management system 30. The grants management system 30 processes the decision rules submitted by each granting agency 34 thereby providing the reviewer and grants manager with guidance as to the particular application fields that need to be considered when reviewing the application.

A lower frame 446 shows “Assessment Attributes”, which are the particular application attributes or fields that the grantor deems important to consider for awarding the grant. The fields may be ranked in order 448 of importance. For instance, as shown, the fields that are considered important for the particular application being assessed by the granting agency 34 and evaluated by the reviewer may be organizational standing, funding, and geographic distribution. The reviewer then proceeds to value 452 each field. In this instance, the organizational standing is valued as excellent, the funding is found excellent, and the geographic distribution is medium, which could indicate that similar grants have been awarded to other applicants in the same geographic area as the applicant. The reviewers could also provide comments 454 regarding each field. A weight 456 would indicate the weight given by the reviewer to the particular field. The reviewer then scores 458 each field. A total raw score 444 is displayed in the middle frame.

The grants management system 30, either simultaneously or after the reviewer has finished assessing the application, proceeds to assess the application using a Decision Rule Data Structure stored in the grants management system 30. The Decision Rule Data Structure includes fields provided by the granting agency 34, each decision rule consists of an Application Attribute, which is a field on the application to which the decision rule applies (e.g., State, Congressional District, Zip Code). A Decision Rule is a mathematical formula for calculating the decision rule score. The formula contains the literals ATTRIBUTE, to represent the total for a particular value of an Application Attribute, and TOTAL to represent the total for all awards. For example, to create a decision rule that tries to distribute awards evenly based upon the selected field, and gives this distribution a maximum weight of 100 points in the overall evaluation process, the following formula could be used: 100-((ATTRIBUTE/TOTAL)*100). As the number of awards containing a specific value of an Application Attribute increases, the formula, when evaluated for that attribute, will produce a smaller and smaller value, thereby increasing the likelihood that an award is for an application with a different value for that Application Attribute. A Decision Measure is a field with two possible values, Count and Dollar Amount. A Count is used to evaluate the decision rule based upon the number of grant awards. A Dollar Amount evaluates the decision rule based upon the dollar amount of the awards.

Each time an application is awarded, a Decision Rule Metrics table is updated for each decision rule associated with the grant initiative. If a record exists in the table for the calculated Key, it will be incremented; otherwise, a new record will be inserted. This table contains the following fields: Key: The key to the table. The key will be set to a concatenation of a Grant Initiative ID, the Decision Rule ID, and the Application Attribute. Amount: The amount of awards made for the Grant Initiative/Decision Rule/Application Attribute combination. If the Decision Measure on the Grant Initiative is set to Count, this field will be incremented by 1. If the Decision Measure is set to Dollar Amount, the field will be incremented by the dollar amount of the grant award.

In addition to the Decision Rule Metrics, a second record will be updated in the Decision Rule Metrics Table for each decision rule associated with each awarded grant. This is the totals record, and it maintains the totals for the Grant Initiative/Decision Rule combination. The fields on this record will be set according to the following rules: Key: The concatenation of the Grant Initiative ID and the Decision Rule ID. Amount: If the Decision Measure on the Grant Initiative is set to Count, this field will be incremented by 1. If the Decision Measure is set to Dollar Amount, the field will be incremented by the dollar amount of the grant award.

The grants management system 30 can now perform a keyed read of the Decision Rule Metrics table for each decision rule on each unprocessed application, and determine the dynamic values of the literals ATTRIBUTE (using a concatenation of Grant Initiative ID, Decision Rule ID, and Application Attribute as the key), and TOTAL (using a concatenation of Grant Initiative ID and Decision Rule ID as the key). Using these literals, each decision rule can be evaluated for each grant application.

Once the reviewer provides the raw scores for each field, the grants manager reviews the grant applications and ranks the applications by score and initiative. The grants management system 30 then evaluates the grant application according to the decision rules or decision models, which, in turn, weigh the distribution of any application field, such as geographical location. For instance, assuming that the template for a particular grant has been configured to consider that it is important for the grantor to evenly distribute the grant funds throughout the east coast and assuming that the applicant under consideration is from New York. If the grants management system 30 determines that the particular grant's funds have been mostly awarded in New York, the system would then provide a low score for the geographic distribution field. In the alternative, the grants manager can further modify the score making subjective determinations such as the success of the applicant in past grants in reaching/accomplishing the grant objectives. The score from the reviewers and the grants manager are combined to create a composite score for each application. The grants management system 30 would then display the applications in descending order of composite scores. Once the grants manager approves to obligate the funds, the system may be implemented to incorporate electronic signature where the grants manager would sign.

As shown in the process flow diagram (i.e., operation 174), to be later described, once applications have been reviewed, the grants manager can go to the Reviewed Applications screen, and click a “Rank” applications button (not shown). When the button is pressed, the grants management system 30 evaluates each decision rule for each reviewed application, using the process described above to evaluate the ATTRIBUTE and TOTAL literals. The scores from this process are added to the scores from the manual review process from the reviewer (i.e., weight and score), and this new total is used to rank the applications. This process allows the system to enforce the equal distribution of grants according to any field on the application.

FIG. 3G shows an Application Notes screen where private and shared notes from the reviewer about the application are entered. The shared notes 460 are notes that anyone with access to the application may share. The private notes 462 may only be viewed by the reviewer who created the note. Here, the reviewer may enter the reasons why he or she believes the application should be awarded or rejected or any other comments. The reviewer may also include attachments.

FIG. 3H shows an Application Finance screen. Once the grants manager approves a grant, the funds are committed to the particular applicant now grantee. The grants manager approval to obligate the funds also requires financial approval. Once both approvals are applied to the application, an obligation is automatically generated in the financial system.

The tool bar 300 and the navigation bar 304 of the screen are the same as the ones described in FIG. 3D. An upper frame 470 on the right portion of the screen displays the application approved by the grants manager. The lower frame 472 shows an application finance frame including multiple finance fields. An “Application” text window 474 shows the name of the application, an “Account” text window 476 shows the organization associated with the application, and a text window next to the “Account” text window shows the site/State 478 where the organization is located.

The lower frame 472 also displays the date the grant initiative was created 480 and the date grant initiative was received 482. The start date text window 484 and the end date text window 486 display the starting and ending dates of the grant initiative offering. A “Closed by Agency” check box 488, which is checked once the payments for grant are complete. The lower frame also displays a stage of the application 490, and an “Accounting Template (*)” 492, which is linked to a set of accounting codes in the financial system. Thus, the grants manager does not need to be familiar with the codes used by the financial systems. The grants manager only needs to know the type of template typically used for the particular type of grant initiative being considered, for example, “ZZ AZ Bioresearch w BOC”. A “Com. Doc #” 494 and an “Obl. Doc #” 496 are identification numbers used for administrative purposes between the grants management system 30 and the financial management system 32. A status text window 498 displays the current status of the application. A “Current Comm. Amt” 480 is the current committed amount of funds awarded to the applicant after the reviewers and grants manager approved the application. The “Revised Comm. Amt” text window is used to enter an updated commitment amount.

An “Initiative” text window 500 displays the application's initiative and an “Est. Budget (of application)” text window 502 displays the estimated amount that the application needs to accomplish its objectives. A “Current Obl. Amt” text window 504 displays the current obligated amount, a “Revised Obl. Amt” text window 506 allows the revised obligated amount to be entered, a “Program Income” text window 508 displays the program income, and a “Total Funding” text window 510 displays the total funding.

A “GM Approval (Commitment)” text box 512 includes a check box “Approved” 514, which would be checked after the grants manager approves the application for commitment. A “user” text window 516 is the user ID of the grants manager who applied a commitment approval. A “Date/Time” text window 518 is the date and/or time the grants manager approved the commitment.

A “GM Approval (Obligation)” text box 520 includes a check box “Approved” 522 which would be checked after the grants manager approves the obligation. A “user” text window 524 is the user ID of the grants manager who applied an obligation approval. A “Date/Time” text window 526 is the date and/or time the grants manager approved the obligation.

An “FM Approval (Obligation)” text box 528 includes a check box “approved” 530, which would be checked after the financial manager approves the obligation. A “User” text window 532 includes the user ID of the financial manager who applied an obligation approval. A “Date/Time” text window 534 shows the date and/or time the financial manager approved the obligation.

An interface to the financial system is triggered based on the following events. If the “Financial System Interface” flag is set to TRUE AND a commitment amount is entered AND a grants manager approval is applied, a commitment is sent to the financial system. If the “Financial System Interface” flag is set to TRUE AND an obligation amount is entered AND a grants manager approval is applied AND a finance manager approval is applied (regardless of order), an obligation is sent to the financial system.

FIG. 31 shows an agreement payments screen where the grantee drawdown requests and approved payments are warehoused after a grantee requests payment. See Appendices X and Y. The upper frame of the screen displays the same application fields as the lower frame 472 in FIG. 3H showing an application finance frame including multiple finance fields.

The lower frame 540 shows payment requests. A title bar displays “Document Date” 544, which is the date of the payment request, “Document Type” 546, which is the document type within the financial system, “Document Number” 548, which is the identification number within the financial system “Accounting Line” 550 which is the line identification number within the financial system and “Status” 552, which is approved, and the financial manager may also include comments (not shown) indicating the reasons for approving the payment request. Further, in this screen, the financial manager would have a list of all the payment requests made by the grantee for a particular application, the date the requests were made, and the status of each one of them.

An interface to the financial system is triggered based on the following events. If the “Financial System Interface” flag is set to TRUE AND a payment amount is entered AND a finance manager approval is applied, a payment request is sent to the financial system.

Furthermore, the “Applications” screens would include an agreement accruals screen (not shown), which the financial manager would access and where financial accruals based upon completed milestones are displayed. See Appendix Z.

An interface to the financial system is triggered based on the following events. If the “Financial System Interface” flag is set to TRUE AND an accrual amount is entered AND a finance manager approval is applied, an accrual is sent to the financial system.

Further, an agreement income screen (not shown) would display income related to the grant program. See Appendix AA. A closed agreement screen (not shown) would display all the grant agreements that have been closed. This screen may be accessed by the grants manager via the grants management system 30 or by the financial manager via the financial management system 32.

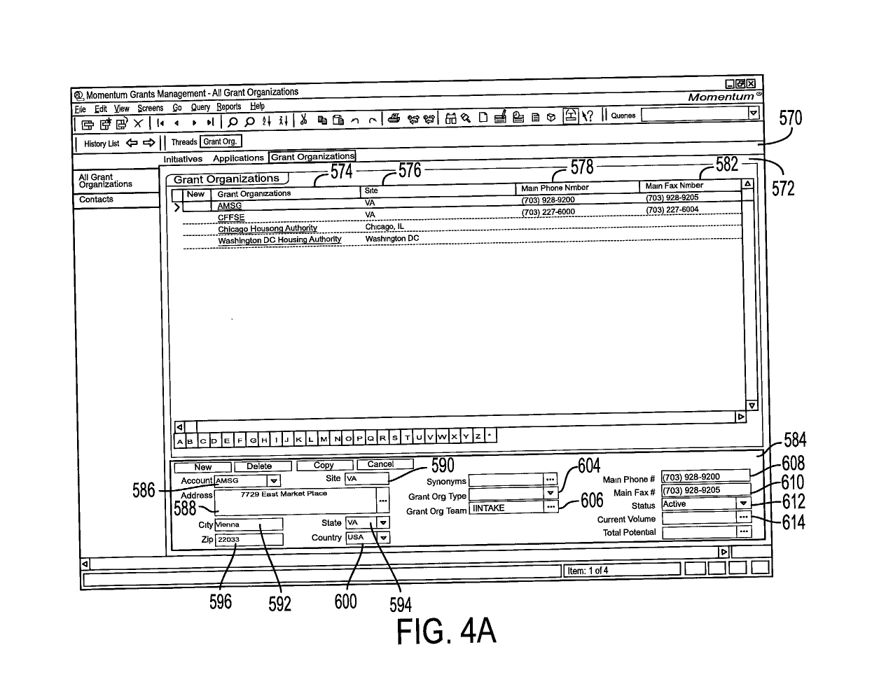

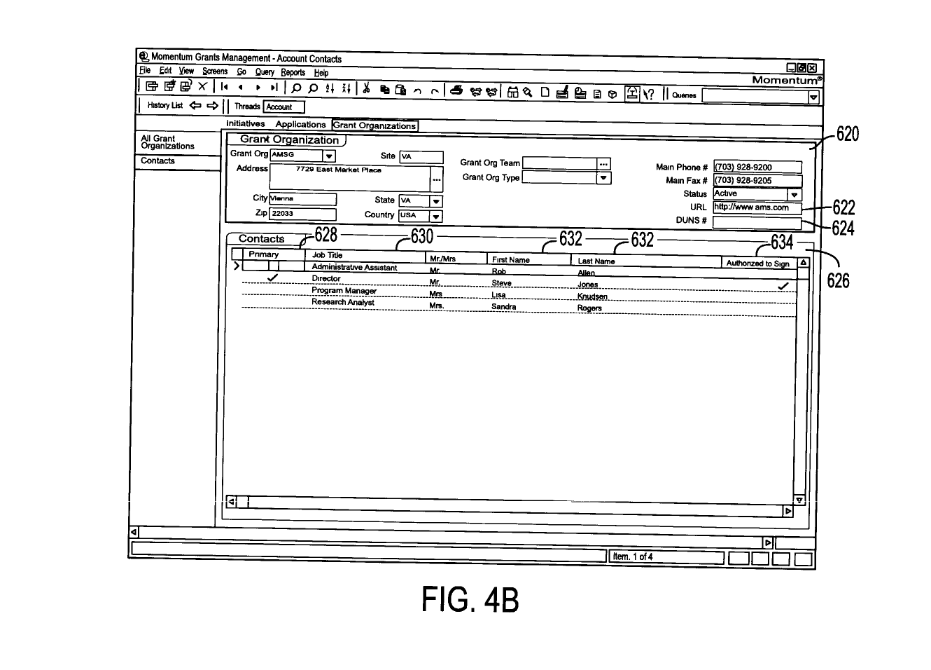

FIG. 4A shows an “All Grant Organizations” graphical user interface screen where all current and past grant recipient organizations are listed. See Appendix L. In the top portion of the screen, a title bar 570 lists “Initiatives” screens, “Applications” screens, and “Finance Summary” screens. The upper frame 572 of the screen lists all the grant recipient organizations 574, the site/State 576 where the organization is located, their telephone numbers 578, and fax numbers 580. If the organization is a new 582 organization to the system, it is marked accordingly. The lower frame 584 of the screen includes data fields such as name of the granting agency 586, address 588, site 590, city 592, state 594, zip 596, and country 600. Further, the application fields also include granting agency type 604, granting agency team 606, main phone 608, fax number 610, status 612, current volume 614, which is a number used for administrative purposes.

FIG. 4B shows “Organization Contacts” graphical user interface screen for all the contacts for the grant recipient organization. The upper frame 620 provides for the e-mail address 622 of the grant recipient organization and DUNS (“Dun and Bradstreet Number”) numbers 624. The lower screen 626 displays the lists of contacts, which include whether the contact is a primary contact 628, job title 630, name 632, and whether the contact has signatory authority 634.

The MGMS 10 further generates a group of finance summary screens that the finance manager would access to monitor transactions such as payment requests, accruals, and program income. See Appendix AB. More particularly, a finance summary screen (not shown) of all the financial transactions for each grant agreement is generated.

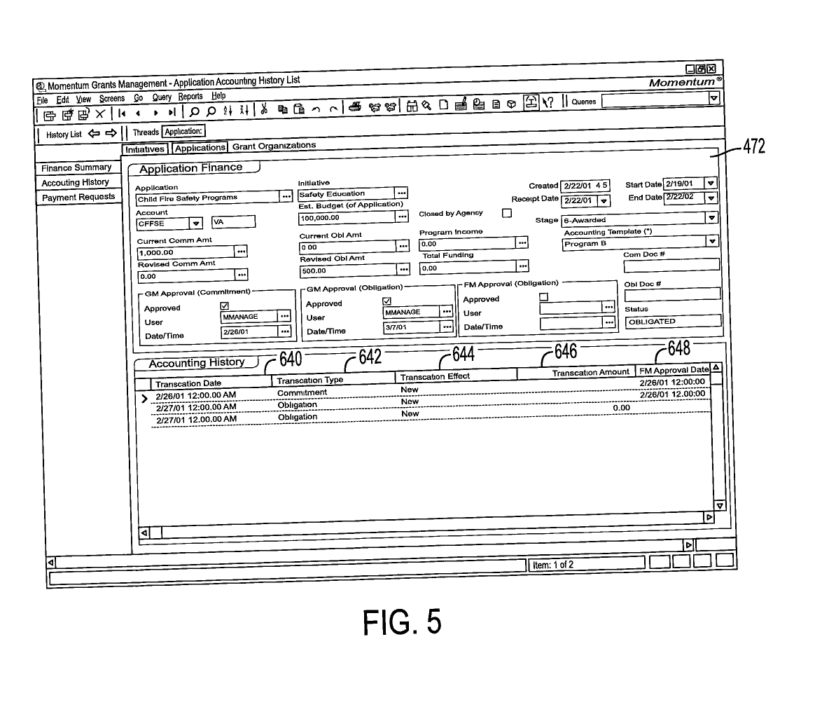

More particularly, FIG. 5 shows an accounting history screen displaying the application data fields as shown in FIG. 3H. In addition, the accounting history of a particular application is described. See Appendix AC. For instance, a date of the transaction 640, the type of transaction 642, a transaction effect 644 (i.e., whether it is a new transaction, pending, or completed transaction), the amount of the transaction 646, and the date the financial manager approved the transaction 648 are shown. A payment request screen (not shown) would display all unapproved grantee drawdown requests, regardless of the grant agreement. Under each payment request, the date of the document, document type, document number, accounting line, and status would be displayed. Further, the screen includes comments from the grantee requesting the payment. The PMS/ASAP 38, for instance, would receive a notification from the financial management to disburse the payments.

The events or the grants process flow performed by the MGMS 10 to dynamically manage a grant initiative will be now described. The grants process flow includes initiative setup process, pre-application intake process, reviewer assignment process, a review and ranking process, grant award or grant initiative selection process, requests of grants financial activities process, information transfer process, and financial close out process.

As shown in FIG. 6A, at operation 702, the initiative setup process begins where internal grant specifications are collected from the granting agency 34 to be loaded into the grants management system 30. At operation 704, the grants manager or the program grants manager administrator from the granting agency 34 enters or updates descriptive information about a grant. For instance, the agency offering the grant, the type of initiative (i.e., community development, general research, housing, medicine, etc.), the CFDA number, parent campaign, purpose, initiative attributes, and summary. The administrator specifies the nature of the grant, amount of money available, and the set of customized criteria pertaining to the grant. The criteria would later be processed to determine therefrom the reviewers that would be best qualified to review the applications for the particular grant. The criteria would include information that the applicant would need to submit to apply for the particular grant. See FIG. 2G.

If, while filling out the application form the applicant has questions or runs into problems, the applicant may submit the question or concern, via e-mail for instance, to the agency using the Web server. See FIG. 2K. The grants management system receives the questions from the Web server, processes the question, and directs the question to a particular individual at the granting agency 34 qualified to answer the question. The granting agency 34 would return a response via the “Review Status of Questions” screen. See FIG. 2L.

At operation 706, an intake, which is a person at the agency responsible for receiving grant applications, sets a mailing/notification list of potential and past applicants. That is, the intake would look in a database listing, such as a standard mailing list all the individuals or agencies that have made inquires about particular grants or have applied for particular grants in the past.

At operation 708, a determination is made whether the grant agency is ready to publish the Notice of Funding Availability (“NOFA”) or grant initiative to the world, for instance through the web. If the grant is not ready for publication, the process returns to operation 704 so that the grants manager or program administrator continues to enter or update the information descriptive about the grant initiative. Further, after the information about the grant is published in the web, the grants manager or program administrator may update the information regarding the grant at any time. If the grant is ready to be published, at operation 710, the grants manager checks “publish to web” box on the initiative. See FIG. 3A. At operation 712, the web engine or Web server 20 displays all the grant initiatives that are ready to be published. In the alternative, the system may automatically process the grant information and e-mail or send by regular mail the information using the mailing address stored in the database of potential applicants.

At operation 714, e-mails/print fulfillments are dynamically or automatically triggered for all identified potential applicants. Specifically, those individuals or agencies that have registered with the grants management system 30 inquiring into grants for particular initiatives (i.e., community development, housing, or medical) in the past, would receive e-mails or notifications notifying them of the availability of funds for those initiatives.

In the alternative, as illustrated in FIG. 3A, the grants manager selects from a focus text window the type of initiative ready to be published. In turn, the grants management system 30 would automatically sort and retrieve the information from the database storing e-mail or mailing addresses regarding those individuals or agencies interested in the grant available and notify them. For instance, the database would include the last name of the applicants, first name of the applicants, type of initiative or initiatives in which the applicant is interested, work phone, home phone, work fax, e-mail address, mailing address, date/time the applicant's information was entered, a flag indicating whether a notification was sent to the applicant, and date/time the notification was sent to the applicant.

As shown in FIG. 6B, at operation 720, the pre-application and application intake begins. Specifically, Applicants can search published grant initiatives online, viewing all applicable information pertaining to a particular initiative and corresponding attachments. At operation 722, the applicant applies for the particular grant initiative in which he or she is interested. The application may be either online, hard copy (mail), or in person. At operation 724, the applications for the particular grant initiative are received and the grants management system changes the status attribute of the particular application for the particular grant initiative as “submitted to agency.” If the application is submitted by mail or in person, the program administrator would load the information into the grants management system 30. At operation 726, a determination is made whether the applicant is a new applicant. If the applicant is a new applicant, at operation 728, the grants management system 30 would set up an account for the new applicant by entering the account data related to the applicant. Otherwise, at operation 730, the grants management system 30 retrieves the applicant's information from the database and the application is processed.

At operation 732, the application is edited, questions from the applicant are answered either via e-mail, regular mail, fax, or telephone, the different activities required to review the application adequately are determined, notes are added, and if the application was submitted in person or by regular mail, fax, the data is inputted into the forms provided by the grantor for the particular grant. At operation 734, upon review of the information submitted by the applicant, a determination is made by the grants management system 30 or in the alternative, by the grants manager whether the information submitted in the application is incomplete. If the application is not complete, at operation 736, the grants manager system dynamically notifies the applicant of problems associated with the application submitted, such as incomplete or inconsistent information, and asks for revisions. The notification may be done by a letter send via regular mail, fax or via e-mail, which would direct the applicant to go online, access the application, and revise the application. See FIG. 3E. “Application Activities.”

Once the applicant receives a notice that additional information is required, the applicant would go online. The applicant would access the main screen, which is the “All Applications” screen and click on the particular application number specified in the e-mail or letter. See FIG. 3D The “Application Activities” screen would display the revisions or additional information required by the grants management system 30. See FIG. 3E.

If the application is complete, at operation 738, the application stage is changed from “application submitted” to “logged at agency.” At operation 740, the grants management system 30 reviews the application for basic criteria and compliance, which are provided by each granting agency 34. At operation 742, a determination is made whether the application meets the basic criteria and compliance. If the application does not meet the basic criteria, at operation 744, e-mail is sent to the applicant notifying that the application is rejected. The reasons supporting the rejection would be provided in the “Application Activities” screen for the applicant to review. See FIG. 3E, “application activities.” If the application does meet the requirements, then at operation 746, the grants management system 30 dynamically or automatically processes and selects, based on the application, workload, and skills of the reviewers, the reviewer(s) that is best qualified to review the application. In the alternative, the grants manager may assign specific reviewers to review the applications. In an exemplary embodiment, operations 740 to 744 may be optionally processed, where from operation 738, the grants management system 30 would proceed to operation 746.

As shown in FIG. 6C, at operation 750, the reviewer assignment process proceeds when the grants management system 30 evaluates the data fields of the application (e.g., area, site/State). At operation 752, the grants management system 30 evaluates the expertise that a reviewer would need to have to review the application and evaluates the workload of those reviewers to find the best-qualified reviewers to review a particular application. At operation 754, the grants management system 30 evaluates the reviewers' workloads based upon assigned applications. At operation 756, the system matches the data fields of applications to the skills of the reviewers. At operation 758, the system rates the reviewers based upon skills that would match the expertise required to review and evaluate the application and the workloads of the reviewers. At operation 160, the system assigns the application to the reviewers with the highest ratings. The process of assigning the grant initiative application to specific reviewers is performed dynamically or automatically by the grants management system 30. A person of ordinary skill in the art will appreciate that a grant manager may also do the selection of reviewers manually.

At operation 762, the applications are marked as under review and appear in the reviewers' queues. At operation 764, the grants management system 30 notifies the reviewers via e-mail that an application has been assigned to them. The reviewers could then access online those applications that have been assigned to them for review.

In an exemplary embodiment, the grants manager may override the reviewers that the grants management system 30 has determined to be best qualified to review the application and assign different or additional reviewers to the application. Further, typically reviewers are not allowed to collaborate when evaluating an application. However, the grants manager may authorize and facilitate collaboration between reviewers. Thus, the system enhances productivity for the granting agency 34 because it is a fully integrated customer relationship management system that provides a consolidated picture of the diverse set of activities that are happening with a grant or organization or staff member at any given time. The system further facilitates collaboration between reviewers by providing a screen with “shared notes,” which the reviewers may share. However, the “notes” screen, to be later described, is dedicated to each reviewer and cannot be accessed by other reviewers, unless access has been authorized. See FIG. 3G.

As shown in FIG. 6D, at operation 770, the review and ranking process begins where the reviewer receives the applications to review. If the reviewer is within the agency, then the reviewer may receive the application via the thin client. If the reviewer is located at a remote location, then the reviewer may access the application via the web. At operation 772, the reviewer assesses the application using a template configured in the grants management system 30 for the particular application under review. The template would include the data fields that the reviewer needs to consider. See FIG. 3F. Further, the reviewer may enter notes about the application, which include comments and reasons supporting awarding or rejecting the grant. See FIG. 3G. The reviewer would also complete any other activities as indicated by the grants management system 30. See FIG. 3E.

At operation 774, the reviewer marks the application as “reviewed by me.” At operation 778, the system aggregates the raw scores across multiple reviewers. At operation 780, the grants manager then has access to a list of the grant applications assessed by the reviewers. Grant initiative, application name, the final score received, stage, and account would categorize the list of grant applications. The grants manager selects to “rank” the applications by final score within the same grant initiative. At operation 782, once the reviewer has manually reviewed the application, the grants management system 30 evaluates the grant application according to the Decision Rule Data Structure or the grant program's decision models stored in the grants management system 30. At operation 784, the decision models weight the distribution of any application field (e.g., a decision model based upon the State of the applicant that would ensure even geographical distribution of grants). At operation 786, the applications are given an additional score, based upon the results of the grants management system 30. At operation 788, the additional score is combined with the raw scores to create a composite score for each application. At operation 190, the grants management system 30 displays the applications belonging to the same initiative in descending order of composite scores. At operation 192, the grants management system 30 regenerates scores as additional awards are made.

As shown in FIG. 6E, at operation 800, the grants manager selects the application(s) for award. The grants manager may apply additional decision rules in addition to the decision rules applied by the grants management system 30 and by the reviewers. At operation 802, the grants manager changes the application status to “5-under negotiation,” indicative that the details of a contract for a grant are under negotiation between the grantor and applicant/grantee. At operation 804, the grants manager commits funds for the applicant account. Committing the funds only requires the approval from the grants manager. At operation 806, the grants management system 30 interfaces with the financial system through the EAI tool 36. See FIG. 3H. At operation 808, the grant specification and requirements are negotiated between the applicant and the financial manager either in person or by telephone. The details of the grant are discussed, such as the amount of money the grants manager has committed and additional requirements that the applicant needs to fulfill the terms of the grant award.

At operation 810, a determination is made as to whether to award the grant to the applicant. If the grant is not awarded to the applicant, at operation 812, the status of the application is changed to “rejected.” At operation 814, e-mail notification is automatically sent to the applicant informing the applicant that the application was not awarded the grant. In the alternative, the process may automatically generate a letter sent via regular mail or a fax notifying the applicant that the application was rejected. However, if the grant is awarded, at operation 816, the status of the application is changed to “awarded.” At operation 818, the funds are obligated to the grantee based on the agreement accounting rules, which both, the grants manager and the financial manager must approve.

As shown in FIG. 6F, at operation 830, payment requests included in the grants financial activities process begins where the grantee logs onto the grants management web site. At operation 832, the grantee enters a payment request where the grantee would include information such as amount requested, what the amount would be used for, etc. At operation 834, the financial manager receives the payment request, processes the requests, and approves the request. At operation 836, the financial management system 32 interfaces with the grant financial management system 32 and at operation 838, the drawdown is made available to the grantee. At operation 840, the payment status is updated on the website and an e-mail is sent to the grantee notifying and confirming the payment.

At operation 842, accruals in the grants financial activities process begins where the grantee notifies the granting agency 34 of a milestone completion via e-mail, online, telephone, or in person. The process may also automatically send out e-mails to the grantee when progress report deadlines are imminent. The e-mail prompts the grantee to click on an embedded link directing him or her to the web page where to submit the progress report. If the grantee is late in submitting his progress report, the grants management system 30 sends e-mail to the appropriate granting agency 34 staff member prompting the granting agency 34 to follow up with the grantee.

At operation 844, the financial manager enters an accrual record based upon the activity. At operation 846, the financial manager approves the accrual. At operation 848, the financial management system 32 interfaces with the grant financial management system 32 and at operation 850, the grants management system 30 records the funds as expended.

At operation 852, a program income in the grants financial activities process begins where the grantee reports any income or interest accrued from the program or grant to the agency. At operation 854, the financial manager records the income in the financial management system 32. At operation 856, a determination is made whether the income was deposited with the granting agency. If the income was not deposited, then at operation 858, a record of additional funding is made in the grants management system 30. Otherwise, if the income was deposited, at operation 860, a record of collection is made in the financial management system 32.

As shown in FIG. 6G, at operation 870, an information transfer process flow is described where the different ways to communicate between the grantee, the grants management system 30 and the financial management system 32. The process allows the grantee, the grants management system 30, and the financial management system 32 to work collaboratively. Specifically, at operation 870, the grantee sends financial reports, activity summaries, and updates via the Internet, regular mail, fax, or in person to grants management system 30. If the information were submitted by regular mail, fax or in person, the grants manager would enter the information into the grants management system 30. The financial management system 32 would then access the information from the grants management system 30 via the EAI tool 36. At operation 872, the grantee communicates with the granting agency or grantor through the Internet, telephone, mail, or in person. At operation 874, the financial management system 32 via the grants management system 30 reviews the grantee's financial reports, milestones, and award compliance.

At operation 876 a determination is made at the financial management system 32 whether the grantee is compliant. If the grantee is does not comply, at operation 878, the grants management system 30 may automatically send e-mail notifying the grantee of the problems. The grantee would then login to the grants management web portal via the Internet to review the problems. In the alternative, the financial manager would contact the grantee directly to discuss the problems and request clarification. At operation 880, the financial management system 32 via the grants management system 30, receives further financial reporting and verifies award compliance. However, if it is determined that the grantee is complying, at operation 882, the grant management process continues.

At operation 884, a determination is made, in view of the newly received information, whether the grantee is complying. If the grantee is complying, the process proceeds to operation 882. Otherwise, at operation 286, the grant award is terminated and a delinquency report is generated to the proper agencies.

As shown in FIG. 6H, at operation 890, the financial close out process begins, which is dynamically performed by the grants management system 30 and the financial management system 32. At operation 892, the final grant financial reports online are accepted. At operation 894, the grants manager and the financial manger review the financial reports or statements. At operation 896, a determination is dynamically made by the financial management system 32 whether the financial reports are acceptable, that is, whether the financial reports include all the necessary information to be processed and whether the reports are overdue. The grants management system 30 would automatically trigger an e-mail to the grants manager, the financial manager, and/or grantee about the status of the financial reports or other activities and milestones. If the financial reports are not acceptable, at operation 898, the grantee is informed of errors via e-mail, telephone, or regular mail, fax and is requested to resubmit the statements and the process returns to operation 898. However, if the financial reports are acceptable, at operation 900, the financial manager marks the grant agreement as closed. At operation 902, the grants manager marks the grant agreement as closed by the granting agency and the grantee.

At operation 904, a determination is dynamically made by the financial management system 32 whether the drawdowns exceed accruals. If the drawdowns do not exceed accruals, then at operation 906, all drawdowns are accrued in the financial management system 32. The process proceeds to operation 908. However, if the drawdowns do exceed accruals, at operation 908, a determination is dynamically made by the financial management system 32 whether the obligations exceed the drawdowns. If the obligations do exceed the drawdowns, at operation 910, the obligations are reduced to equal the drawdowns. The process proceeds to operation 912. However, if the obligations do not exceed the drawdowns, at operation 912, a determination is dynamically made by the financial management system 32 whether commitments exceed obligations. If the commitments do exceed the obligations, at operation 914, the commitments are reduced to equal the obligations. The process proceeds to operation 916. However, if the commitments do not exceed the obligations, at operation 916, the grant agreement status is updated to “closed.”

In an alternative embodiment, the MGMS 10 may be applied to financial aid loans, housing lotteries, grants to college students, request for proposal management, scholarships, any type of application for competitive review, and state or federal loans.

The many features and advantages of the invention are apparent from the detailed specification and, thus, it is intended by the appended claims to cover all such features and advantages of the invention, which fall within the true spirit, and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A multi-channel grants management system, comprising:
a grants management system operatively connected to a granting agency and a financial management system; and
an integration unit providing real-time integration between the grants management system and the financial management system allowing the grants management system to dynamically manage grant initiative transactions and financial transactions associated with a life-cycle of a grant initiative from the granting agency by automatically triggering events.

2. The system as recited in claim 1, wherein the multi-channel grants management system provides multi-communication access to the grant initiative and the financial transactions, and file exchange to a user over a web-based portal, e-mail, a telephone, fax, or in person.

3. The system as recited in claim 1, wherein the life-cycle comprises pre-application, grant publication, application intake, application review or assessment, grant award, grant administration, and grant closeout.

4. The system as recited in claim 1, wherein the integration between the grants management system and the financial management system allows a user to communicate over a web-based portal with the grants management system and the financial management system.

5. The system as recited in claim 1, the integration unit facilitates transmission and messaging between the grants management system and the financial management system.

6. The system as recited in claim 5, wherein the integration unit triggers updates to the financial management system whenever an activity in the grants management system has financial significance.

7. The system as recited in claim 1, wherein the events comprise
an initiative setup process,
a pre-application and an application process,
a reviewer assignment process,
a review and ranking process,
a grant initiative selection process,
a requests of grants financial activities process,
an information transfer process, and
a financial close out process.

8. A multi-channel management system, comprising:
a financial management system; and
a grants management system
receiving a grant initiative from a granting agency,
receiving a grant initiative application from an applicant via one of a web-portal, fax, in-person, and telephone,
integrally connected to the financial management system to facilitate transmission and messaging between the grants management system and the financial management system, and
dynamically managing grant initiative transactions and financial transactions associated with a life-cycle of the grant initiative by automatically triggering events.

9. The multi-channel management system as recited in claim 8, wherein the multi-channel grants management system provides multi-communication access to the grant initiative and financial transactions, and file exchange to a user over a web-based portal, e-mail, a telephone, fax, or in person.

10. The multi-channel management system as recited in claim 8, wherein the life-cycle comprises pre-application, grant publication, application intake, application review or assessment, grant award, grant administration, and grant closeout.

11. The multi-channel management system as recited in claim 8, wherein the grants management system triggers updates to the financial management system whenever an activity has financial significance.

12. The multi-channel management system as recited in claim 8, wherein the grants management system, simultaneously or after a reviewer has finished assessing the application, assesses the grant initiative application using a customizable decision rule data structure.

13. The multi-channel management system as recited in claim 8, wherein the grant initiative application is a customizable WYSIWIG application form.

14. The system as recited in claim 1, wherein the events comprise
an initiative setup process,
a pre-application and an application process,
a reviewer assignment process,
a review and ranking process,
a grant initiative selection process,
a requests of grants financial activities process,
an information transfer process, and
a financial close out process.

15. A system, comprising:
a web-based portal;
a grants management system
receiving a grant initiative from a granting agency via the web-based portal,
receiving a grant initiative application from an applicant via one of fax, thin client, in-person, and telephone and entering the grant initiative application via the web-based portal,
dynamically selecting a reviewer that is best qualified to review the application according to the grant initiative from the granting agency and to generate a score,
dynamically evaluating the grant initiative application using customizable decision rule data structures and generating a score,
combining the scores from the reviewer and the grants management system to create a composite score to determine an application to award the grant initiative;
a financial management system managing financial information of the grant initiative; and
an integration unit facilitating transmission and messaging between the grants management system and the financial management system to dynamically manage grant initiative transactions and financial transactions associated with a life-cycle of the grant initiative by automatically triggering events comprising an initiative setup process, a pre-application and an application process, a reviewer assignment process, a review and ranking process, a grant initiative selection process, a requests of grants financial activities process, an information transfer process, and a financial close out process, with the life-cycle comprising pre-application, grant publication, application intake, application review or assessment, grant award, grant administration, and grant closeout.

16. The multi-channel management system as recited in claim 15, wherein the multi-channel grants management system provides multi-channel communication access to the grant initiative and financial transactions, and file exchange to a user over a web-based portal, e-mail, a telephone, fax, or in person.

17. The system as recited in claim 15, wherein the integration unit triggers updates to the financial management system whenever an activity in the grants management system has financial significance.

18. The system as recited in claim 15, wherein the grant initiative application is a customizable WYSIWIG application form.

19. A method, comprising:
operatively connecting a grants management system to a granting agency and a financial management system; and
providing real-time integration between the grants management system and the financial management system allowing the grants management system to dynamically manage grant initiative transactions and financial transactions associated with a life-cycle of a grant initiative from the granting agency by automatically triggering events.

20. The method as recited in claim 19, wherein the events comprise
an initiative setup process,
a pre-application and an application process,
a reviewer assignment process,
a review and ranking process,
a grant initiative selection process,
a requests of grants financial activities process,
an information transfer process, and
a financial close out process.

21. A method performed by a grants management system, comprising:
receiving a grant initiative from a granting agency via a web-based portal;
automatically retrieving and notifying a potential and/or past applicant of availability of the grant initiative;
receiving a grant initiative application from an applicant via the web-based portal;
dynamically evaluating the grant initiative application using customizable decision rule data structures and generating a score; and
interfacing with a financial management system to dynamically manage grant initiative transactions and financial transactions associated with a life-cycle of the grant initiative by automatically triggering events.

22. The method as recited in claim 21, wherein the events comprise
an initiative setup process,
a pre-application and an application process,
a reviewer assignment process,
a review and ranking process,
a grant initiative selection process,
a requests of grants financial activities process,
an information transfer process, and
a financial close out process.

23. The method as recited in claim 21, wherein the life-cycle comprises pre-application, grant publication, application intake, application review or assessment, grant award, grant administration, and grant closeout.

24. A method, comprising:
applying for a grant initiative over a web-based portal;
dynamically notifying an applicant of problems while applying for the grant initiative;
receiving a grant initiative application;
dynamically selecting a reviewer that is best qualified to review the grant initiative application according to the grant initiative;
notifying the reviewer of the grant initiative assigned for review;
evaluating the grant initiative application using customizable decision rule data structures and generating a score; and
interfacing with a financial management system to dynamically manage grant initiative transactions and financial transactions associated with a life-cycle of the grant initiative by automatically triggering events.

25. The method as recited in claim 24, wherein the events comprise
an initiative setup process,
a pre-application and an application process,
a reviewer assignment process,
a review and ranking process,
a grant initiative selection process,
a requests of grants financial activities process,
an information transfer process, and
a financial close out process.

26. The method as recited in claim 24, wherein the dynamically selecting the reviewer comprises:
dynamically evaluating attributes or data fields of the grant initiative application;
dynamically evaluating expertise and workload of the reviewer; and
dynamically rating the reviewer based on the expertise and the workload.

27. The method as recited in claim 24, further comprising automatically triggering e-mail to a grants manager, a financial manager, and/or an applicant about a status of the grant initiative, financial reports, or grant activities.

28. A method, comprising:
receiving an application for a grant initiative;
dynamically selecting a reviewer that is best qualified to review the application according to the grant initiative, with the selected reviewer evaluating the grant initiative application and generating a score;
dynamically evaluating the grant initiative application by a grants management system using customizable decision rule data structures and generating a score; and
combining the scores to create a composite score used to determine the application to award the grant initiative.

29. A method performed by a grants management system, comprising:
receiving a grant initiative from a granting agency via a web-based portal;
receiving a grant initiative application from an applicant via the web-based portal;
dynamically selecting a reviewer that is best qualified to review the application according to the grant initiative from the granting agency and to generate a score;
dynamically evaluating the grant initiative application using customizable decision rule data structures and generating a score;
combining the scores from the reviewer and the grants management system to create a composite score to determine an application to award the grant initiative;
managing financial information of the grant initiative by a grants management system by automatically triggering events comprising a requests of grants financial activities process, an information transfer process, and a financial close out process; and
interfacing with a financial management system to dynamically manage grant initiative transactions and financial transactions associated with a life-cycle of the grant initiative, with the life-cycle comprising pre-application, grant publication, application intake, application review or assessment, grant award, grant administration, and grant closeout.

30. A method to close a grant initiative agreement in a multi-channel grants management system, comprising:
accepting final grant financial reports via a web-portal;
reviewing the financial reports;
informing a grantee of errors;
marking grant agreement as closed by a financial management system and a grants management system;
dynamically determining whether drawdowns exceed accruals and instructing, when it is determined that the drawdowns exceed accruals, to accrue all the drawdowns in the financial management system;
dynamically determining whether obligations exceed the drawdowns and instructing, when it is determined that the obligations exceed the drawdowns, to reduce obligations to equal the drawdowns;
dynamically determining whether commitments exceed the obligations and instructing, when it is determined that the commitments exceed the obligations, to reduce the commitments to equal the obligations; and
closing the grant initiative agreement.

31. A computer readable storage medium controlling a computer and comprising a process of operatively connecting a grants management system to a granting agency and a financial management system; and providing real-time integration between the grants management system and the financial management system allowing the grants management system to dynamically manage grant initiative transactions and financial transactions associated with a life-cycle of a grant initiative from the granting agency by automatically triggering events.

32. The computer readable storage medium as recited in claim 31, wherein the events comprise an initiative setup process, a pre-application and an application process, a reviewer assignment process, a review and ranking process, a grant initiative selection process, a requests of grants financial activities process, an information transfer process, and a financial close out process.

33. A computer readable storage medium controlling a computer and comprising a process performed by a grants management system of receiving a grant initiative from a granting agency via a web-based portal; automatically retrieving and notifying a potential and/or past applicant of availability of the grant initiative; receiving a grant initiative application from an applicant via the web-based portal; dynamically evaluating the grant initiative application using customizable decision rule data structures and generating a score; and interfacing with a financial management system to dynamically manage grant initiative transactions and financial transactions associated with a life-cycle of the grant initiative by automatically triggering events.

34. The computer readable storage medium as recited in claim 33, wherein the events comprise an initiative setup process, a pre-application and an application process, a reviewer assignment process, a review and ranking process, a grant initiative selection process, a requests of grants financial activities process, an information transfer process, and a financial close out process.

35. The computer readable storage medium as recited in claim 33, wherein the life-cycle comprises pre-application, grant publication, application intake, application review or assessment, grant award, grant administration, and grant closeout.

36. A computer readable storage medium controlling a computer and comprising a process of applying for a grant initiative over a web-based portal; dynamically notifying an applicant of problems while applying for the grant initiative; receiving a grant initiative application; dynamically selecting a reviewer that is best qualified to review the grant initiative application according to the grant initiative; notifying the reviewer of the grant initiative assigned for review; evaluating the grant initiative application using customizable decision rule data structures and generating a score; and interfacing with a financial management system to dynamically manage grant initiative transactions and financial transactions associated with a life-cycle of the grant initiative by automatically triggering events.

37. The computer readable storage medium as recited in claim 36, wherein the events comprise an initiative setup process, a pre-application and an application process, a reviewer assignment process, a review and ranking process, a grant initiative selection process, a requests of grants financial activities process, an information transfer process, and a financial close out process.

38. The computer readable storage medium as recited in claim 36, wherein the dynamically selecting the reviewer comprises: dynamically evaluating attributes or data fields of the grant initiative application; dynamically evaluating expertise and workload of the reviewer; and dynamically rating the reviewer based on the expertise and the workload.

39. The computer readable storage medium as recited in claim 36, further comprising automatically triggering e-mail to a grants manager, a financial manager, and/or an applicant about a status of the grant initiative, financial reports, or grant activities.

40. A computer readable storage medium controlling a computer and comprising a process of receiving an application for a grant initiative; dynamically selecting a reviewer that is best qualified to review the application according to the grant initiative, with the selected reviewer evaluating the grant initiative application and generating a score; dynamically evaluating the grant initiative application by a grants management system using customizable decision rule data structures and generating a score; and combining the scores to create a composite score used to determine the application to award the grant initiative.

41. A computer readable storage medium controlling a computer and comprising a process performed by a grants management system of receiving a grant initiative from a granting agency via a web-based portal; receiving a grant initiative application from an applicant via the web-based portal; dynamically selecting a reviewer that is best qualified to review the application according to the grant initiative from the granting agency and to generate a score; dynamically evaluating the grant initiative application using customizable decision rule data structures and generating a score; combining the scores from the reviewer and the grants management system to create a composite score to determine an application to award the grant initiative; managing financial information of the grant initiative by a grants management system by automatically triggering events comprising a requests of grants financial activities process, an information transfer process, and a financial close out process; and interfacing with a financial management system to dynamically manage grant initiative transactions and financial transactions associated with a life-cycle of the grant initiative, with the life-cycle comprising pre-application, grant publication, application intake, application review or assessment, grant award, grant administration, and grant closeout.

42. A computer readable storage medium controlling a computer to close a grant initiative agreement in a multi-channel grants management system and comprising a process of accepting final grant financial reports via a web-portal; reviewing the financial reports; informing a grantee of errors; marking grant agreement as closed by a financial management system and a grants management system; dynamically determining whether drawdowns exceed accruals and instructing, when it is determined that the drawdowns exceed accruals, to accrue all the drawdowns in the financial management system; dynamically determining whether obligations exceed the drawdowns and instructing, when it is determined that the obligations exceed the drawdowns, to reduce obligations to equal the drawdowns; dynamically determining whether commitments exceed the obligations and instructing, when it is determined that the commitments exceed the obligations, to reduce the commitments to equal the obligations; and closing the grant initiative agreement.
